(19) United States
(12) Patent Application Publication
(10) Pub. No.: US 2025/0067654 A1
(43) Pub. Date: Feb. 27, 2025

(54) SYSTEMS AND METHODS FOR PARTICLE MAPPING

(71) Applicant: THE REGENTS OF THE UNIVERSITY OF CALIFORNIA, Oakland, CA (US)

(72) Inventors: Yu-Hwa Lo, San Diego, CA (US); Zunming Zhang, La Jolla, CA (US); Rui Tang, San Diego, CA (US)

(21) Appl. No.: 18/727,050

(22) PCT Filed: Jan. 9, 2023
(86) PCT No.: PCT/US2023/060339

§ 371 Date: Jul. 5, 2024

Related U.S. Application Data
(60) Provisional application No. 63/266,569, filed on Jan. 7, 2022.

(51) Int. Cl. G01N 15/1433; G01N 15/10

(52) U.S. Cl. CPC G01N 15/1433; G01N 2015/1006

(57) ABSTRACT

Disclosed are methods, systems, devices, materials, and structures for processing a heterogenous particle population. In some aspects, the disclosed technology uses a first imaging device to record first imaging data at high throughput and a particle placement assembly to place the particles exiting from the first imaging device at respective holder positions on a particle holder and acquire second imaging data to record such position information, and correlating the first imaging data of individual particles with position information recorded in the second imaging data.

### CROSS-REFERENCE TO RELATED APPLICATIONS

This patent document claims priorities to and benefits of U.S. Provisional Patent Application No. 63/266,569 entitled “3D IMAGING FLOW CYTOMETER FOR CELL MAPPING” filed on Jan. 7, 2022. The entire content of the aforementioned patent application is incorporated by reference as part of the disclosure of this patent document.

### STATEMENT REGARDING SPONSORED RESEARCH

This invention was made with government support under DA045460 awarded by the National Institutes of Health. The government has certain rights in the invention.

### TECHNICAL FIELD

This patent document relates to systems and methods for processing a heterogenous particle population by correlating particle information acquired using different modalities.

### BACKGROUND

Flow cytometry is a technique to detect and analyze particles, such as living cells, as they flow through a fluid. For example, a flow cytometer device can be used to characterize physical and biochemical properties of cells and/or biochemical molecules or molecule clusters based on their optical, electrical, acoustic, and/or magnetic responses as they are interrogated by in a serial manner. Typically, flow cytometry uses an external light source to interrogate the particles, from which optical signals are detected caused by one or more interactions between the input light and the particles, such as forward scattering, side scattering, and fluorescence. Properties measured by flow cytometry include a particle's relative size, granularity, and/or fluorescence intensity.

### SUMMARY

Disclosed are methods, systems, devices, materials, and structures that among other features and benefits provide for processing a heterogeneous particle population by correlating particle information acquired using different modalities.

Some aspects of the present disclosure relate to a system for processing a heterogeneous particle population that includes object particles and marker particles. The system may include a first imaging device to capture first imaging data of particles of the heterogenous particle population upon the particles travelling through the first imaging device, a particle dispenser in communication with the first imaging device and operable to dispense the particles exiting the first imaging device to a particle holder at respective holder positions; and a second imaging device to capture second imaging data of the particles positioned at their respective holder positions. In some embodiments, the first imaging data may include first sequence information of a first sequence in which the particles are imaged in the first imaging device. In some embodiments, the second imaging data may include second sequence information of a second sequence of the particles corresponding to their respective holder positions in the particle holder. In some embodiments, the system may include a processor and a memory having instructions stored thereon, wherein the instructions upon execution by the processor cause the processor to locate an object particle by correlating, based on sequence information of the marker particles in the first sequence information and in the second sequence, information of the object particle in the first imaging data with information of the object particle in the second imaging data.

Some aspects of the present disclosure relate to a method for processing a heterogeneous particle population that includes object particles and marker particles. The method may include obtaining first imaging data of particles of the heterogenous particle population captured by a first imaging device upon the particles travelling through the first imaging device, wherein the first imaging data comprises first sequence information of a first sequence in which the particles are imaged in the first imaging device; obtaining second imaging data of the particles captured using a second imaging device when the particles are dispensed to their respective holder positions in a particle holder, wherein the second imaging data comprises second sequence information of a second sequence of the particles corresponding to their respective holder positions in the particle holder; and locating an object particle of the heterogeneous particle population by correlating, based on sequence information of the marker particles in the first sequence information and in the second sequence, information of the object particle in the first imaging data with information of the object particle in the second imaging data.

Some aspects of the present disclosure relate to a system for processing a heterogeneous particle population. The system may include a camera-less first imaging device with a scanning light-sheet and one or more spatial masks, a particle dispenser for dispending the particles exiting the first imaging device to a particle holder at respective holder positions, and a second imaging device to obtain second imaging data by imaging the particles at their respective holder positions, wherein the system is operable to correlate the first imaging data and the second imaging data. In some embodiments, the first imaging device is operable to capture first imagine data including or corresponding to (i) 3D side scattering and fluorescent images, (ii) a 2D transmission image, or (iii) both (i) and (ii) of traveling particles. The system may be operable to correlate and/or pool particle information with single-particle resolution from different sources or modalities on the particle level to allow for identifying and/or isolating, from the heterogenous particle population, individual particles with a specific feature or a combination of features indicated in the particle information.

Some aspects of the present disclosure relate to a non-transitory computer readable program storage medium having code stored thereon, the code, when executed by a processor, causing the processor to implement methods for processing a heterogeneous particle population as described herein.

Some aspects of the present disclosure relate to a system, including at least one processor and memory including computer program code which, when executed by the at least one processor, causes the system to effectuate the methods as described herein.

Some aspects of the present disclosure relate to a system, including at least one processor and memory including computer program code which, when executed by the at least one processor, causes the system to effectuate the methods as described herein.

### BRIEF DESCRIPTION OF THE DRAWINGS

FIG. 1A shows a block diagram of an example system in accordance with some embodiments of the present technology.

FIG. 1B shows a block diagram of an example data processing unit in accordance with some embodiments of the present technology.

FIG. 1C shows a flowchart of an example process 160 for processing a heterogeneous particle population in accordance with some embodiments of the present technology.

FIG. 1D shows diagrams illustrating an example embodiment of a system for a high throughput technique to map cell images to cell positions.

FIG. 2 shows a diagram and data plots illustrating example sequence matching results from example implementations of the system of FIG. 1D.

FIG. 3 shows diagrams illustrating example results from example experiments using fluorescent beads mixed with marker beads.

FIG. 4 shows diagrams illustrating example results from human cancer cells.

FIG. 5 shows diagrams illustrating example results from breast cancer cells.

FIG. 6 shows diagrams illustrating example results from liver cells.

FIG. 7 shows diagrams depicting example liver cell clustering from healthy and early-stage NASH samples.

FIG. 8 shows a diagram showing an example embodiment of a method for sequence extraction and image acquisition pipeline from an example embodiment of a 3D imaging flow cytometry (3D-IFC) system.

FIG. 9 shows a diagram showing an example embodiment of a method for sequence extraction and marker bead and cell detection/pipeline from a cell placement platform.

### DETAILED DESCRIPTION

The isolation and analysis of single cells from a heterogeneous cell population has impacted biomedical research profoundly. Single-cell analysis can be broadly divided into two areas, single-cell genomics, and single-cell high content microscopy. The former deciphers the genomic and phenotypical information by detecting gene expressions, mutations, and genetic aberrations in individual cells. The latter provides high-resolution spatial and morphological information and cell-cell interactions. Yet, an existing technology gap is the lack of effective tools that can connect the two types of single-cell information. That is, an effective tool that can directly relate the morphological properties to the genomic properties of a very same cell is needed. The emerging field of spatial biology aims to solve this issue via DNA barcoding technologies. However, current technology such as the 10× Visium platform are unable to resolve single cells. Microlaser dissectors coupled with a high-resolution microscope can provide single-cell resolution, but the throughput is much too slow to be incorporated into the single-cell workflow in most practical applications. Above all, current spatial biology techniques cannot address the problem for non-adherent cells such as lymphocytes, for which the connection between the phenotype and morphology and immune response of the same T cell can be particularly insightful.

The recent advances in image-guided cell sorter or image-guided Fluorescence-Activated Cell Sorting (FACS) system have made good strides towards this goal. By isolating cells of the same image features based on a predefined gating criterion, one can perform downstream genomic analysis with cells of similar imaging characteristics. However, existing image-guided FACS produces only 2D images, lacking the high information contents of 3D imaging modalities such as confocal microscopes and light-sheet microscopes. Few imaging flow cytometers can produce high content 3D images of single cells, much less isolate cells based on the 3D image features due to the technological incompatibility between 3D imagining modalities, cell sorting devices, and the great challenges in real-time processing of 3D images for 3D image-guided cell sorting.

To address the above and other technology gaps, embodiments of the present disclosure relate in some respects to an approach that bypasses the need for real-time 3D image processing and cell sorting. In some embodiments, the technology integrates two hardware components, an imaging flow cytometer (IFC) and a cell placement robot. Example embodiments of the disclosed technology including example (experimental) implementations are described herein.

Disclosed are methods, systems, devices, materials, and structures for processing a heterogeneous particle population. The disclosed technology may be used to correlate and/or pool particle information with single-particle resolution from different sources or modalities on the particle level to allow for identifying and/or isolating, from the heterogenous particle population, individual particles with a specific feature or a combination of features indicated in the particle information. In some embodiments, the disclosed technology may be used to correlate particle information of particles of the heterogenous particle population in particle images acquired using a first imaging device (e.g., an imaging flow cytometer) with particle information (e.g., positions) indicated in second imaging data acquired when the particles are positioned in a particle holder after the particles exit the first imaging device. In some aspects, the disclosed technology uses a 3D imaging flow cytometer (3D-IFC) as the first imaging device to record multi-parameter 3D particle images at high throughput (e.g., throughput of at least 100cells/s, throughput of 1000 cells/s) and a particle placement module including a particle dispenser (e.g., a cell placement robot) and a particle holder (e.g., a filter plate) to dispense the particles exiting the 3D-IFC system to the particle holder in substantially a first-in-first-out (FIFO) manner, e.g., so that the particles on the particle holder have substantially the same order as the particles as they are imaged. In other words, there is a one-to-one correspondence between the recorded particle images by the first imaging device (e.g., cell images acquired using an IFC) and the position of the particles on the particle holder. In some embodiments, the filter plate may be transparent. The particles placed in the particle holder may be imaged using a second imaging device to generate imaging data that indicates the particle sequence of the particles in the placement module. The disclosed technology may match (or referred to as map) the particle sequences from the imaging module (e.g., the first imaging device) and from the placement module to detect and eliminate deletion and misplacement errors to improve accuracy in the correlation of particle information from different sources (e.g., the particle information in particle images acquired using the first imaging device and particle information (e.g., positions) indicated in second imaging data as described herein). Implementations of the disclosed methods, systems, and devices may form a bridge between single-cell molecular analysis and single-cell image analysis to connect phenotype and genotype analysis with single-cell resolution. The disclosed technology has applications in cell analysis, cell line development, and cell-based assays.

In some embodiments, the present technology addresses one or more challenges, including: (a) matching a sequence of hundreds of thousands of particle images obtained based on imaging data from the first imaging device (e.g., 3D-IFC) to a sequence of a substantially same number of particles deposited on the particle holder (e.g., a plate, a substrate), and (b) detecting any errors between the two long sequences to prevent error propagation and accumulation.

To address the first challenge, the present technology involves two or more types of marker particles (or referred to as marker beads) of distinctive features to guide the mapping of a sequence obtained based on imaging data of particles acquired using the first imaging device and a sequence of the particles deposited on the particle holder. In some embodiments, the marker particles may be those that can be recognized by an off-the-shelf imager. By assigning each marker bead a nucleotide symbol (e.g., A, T, C) used for DNA sequencing, the present technology may use a sequencing technique (e.g., a DNA sequencing algorithm) to analyze the sequences from the two resources. Merely by way of example, a DNA sequencing algorithm may be used to match the two long sequences from the IFC and the cell plate. These marker beads serve analogously to “introns,” and the particles of interest (e.g., objective particles, cancer cells, cells from a subject with a pathological condition at issue) between the marker beads can be regarded as “exons.” The marker bead sequence (i.e., introns) may be used to align the two long sequences and then the regions between the marker beads may be interrogated to analyze the particles (e.g., cells) based on their 2D and/or 3D images. The present technology leverages the established bioinformatics tools to support data streams of essentially any length. In addition, by involving the marker particles, a sequence of particles including the marker particles is divided into individual sections each including multiple particles, and therefore the mapping of two such sequences may proceed by processing sections (e.g., mapping two sequences by comparing sections of the two sequence), instead of processing individual particles (e.g., mapping two sequences by comparing individual particles of the two sequence). To address the second challenge, the present technology includes an error detection methodology to identify two major types of errors—deletion errors and misplacement errors—that can occur in the operation scenario of some embodiments.

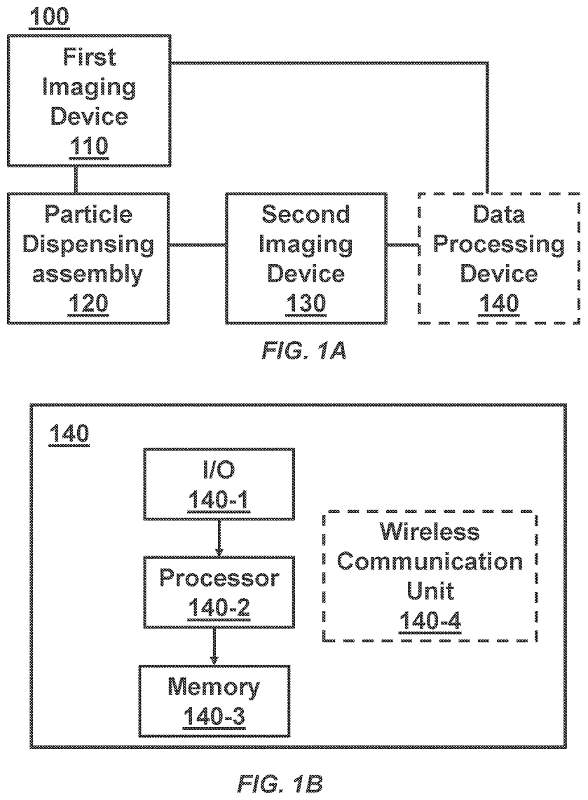

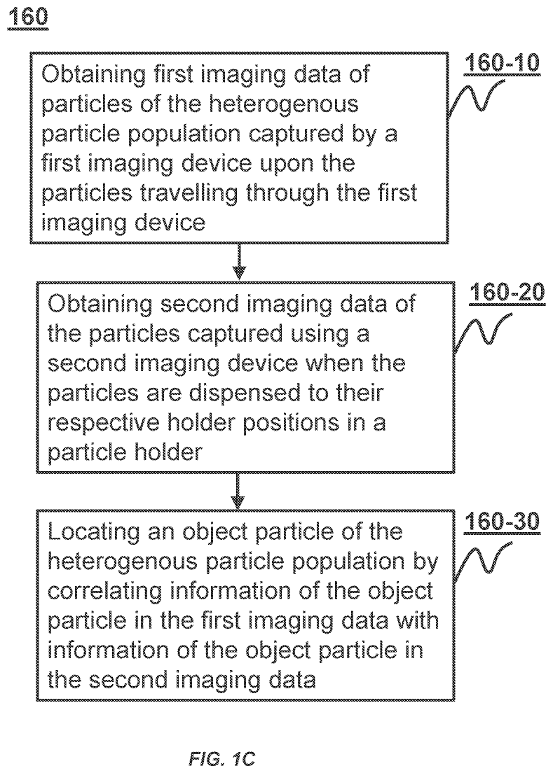

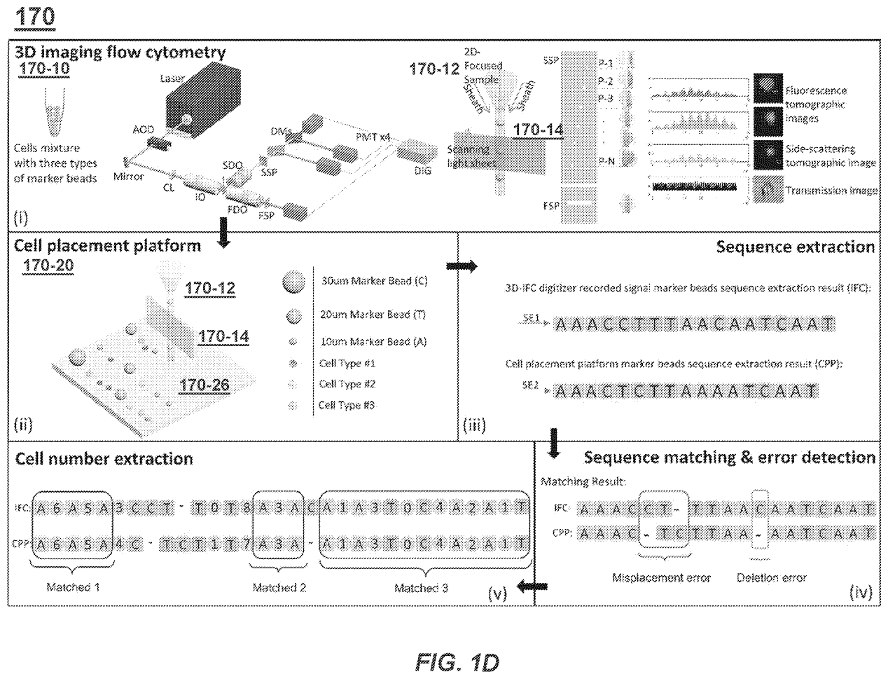

The present technology may bridge the technology gap of relating single-cell molecular analyses to single-cell imaging of non-adherent cells in which individual cells that are imaged may be identified and/or isolated for further analysis including, e.g., genomic analyses, the formation of single cell-derived microcolonies, drug response studies, and metabolic and cell secretion analyses. Although the present disclosure refers to 3D-IFC as a high throughput imaging tool to acquire cell images here, the methodology can be readily applied to other imaging devices including, e.g., 2D imaging cytometers and optical microscopes that can capture images of moving objects and be interfaced with a dispensing system. In some embodiments, the dispensing system (e.g., particle dispensing assembly 120 as illustrated in FIG. 1A) may dispense particles substantially following the first-in-first-out (FIFO) rule. Compared to image-guided FACS systems, the disclosed design can keep particles (e.g., cells, marker particles) entering the dispensing system on a particle-friendly particle holder (e.g., a cell-friendly plate) to support various downstream analyses and processing, e.g., which can allow for retrieval of any individual particles in the particle holder at different times and/or for different purposes. In some embodiments of the present technology, imaging of the particles of the heterogenous particle population using a first imaging device (e.g., a high throughput 3D IFC) precedes the placement of the particles in a particle holder, instead of particle placement before imaging, to take advantage of the high throughput flow cytometers as the mainstay of non-adherent single-cell analysis. The example implementations disclosed herein demonstrate the capability of the disclosed technology to provide a new workflow that can enrich the field of single-particle (e.g., single-cell) research and spatial biology.

As described below, example implementations of some embodiments of the disclosed technology were performed using human cancer cell lines to demonstrate the feasibility of mapping 3D side scattering and fluorescent images, as well as 2D transmission images of cells to their locations on the membrane filter for around 100,000 cells in less than 10 minutes. While the example implementations utilized a specially designed 3D imaging flow cytometer to produce 3D cell images, the disclosed methodology can support other imaging modalities, such as commercial 2D imaging flow cytometers (Imagestream) or microscope systems. The disclosed technology is envisioned to form a bridge between single-cell image analysis and single-cell molecular analysis.

FIG. 1A shows a block diagram of an example system, labelled 100, in accordance with some embodiments of the present technology. The system 100 is operable to process a heterogeneous particle population. The heterogeneous particle population may include particles of various types. In some embodiments, the heterogeneous particle population may include object particles and marker particles. In some embodiments, the object particles may include first object particles of a first particle type. In some embodiments, the marker particles may include first marker particles of a first marker type and second marker particles of a second marker type. The first marker particles and the second marker particles may have features that are distinguishable based on the first imaging data acquired using the first imaging device 110 and/or based on the second imaging data acquired using the second imaging device 130. For instance, individual first marker particles may have a size that is different from individual second marker particles. Merely by way of example, individual first marker particles may have a diameter of 10 micrometers, and individual second marker particles may have a diameter of 20 micrometers. In some embodiments, the heterogenous particle population may further include second object particles of a second particle type different from the first particle type. For instance, the first object particles may include cells from one or more samples with a pathological condition; and the second object particles may include cells from one or more samples with a control condition. In some embodiments, a ratio of the object particle count of the object particles in the heterogenous particle population to the marker count of the marker particles in the heterogenous particle population may be selected based on one or more considerations including, e.g., chances of error (as described elsewhere in the present disclosure), efficiency, etc. For instance, the ratio of the object particle count to the marker count may be set to below 10:1. For example, the ratio may be 8:1, 5:1, 3:1 or 2:1. The efficiency consideration may include or relate to marker particles consumption, and/or marker particles being useful for mapping but not for study of object cells, or the like, or a combination thereof.

The system 100 includes a first imaging device 110, a particle dispensing assembly 120, a second imaging device 130, and a data processing device 140. The first imaging device 110 may capture first imaging data of particles of the heterogenous particle population while the particles travel through the first imaging device. For example, the first imaging device 110 is an imaging flow cytometer. In some embodiments, the imaging flow cytometer is a two-dimensional or three-dimensional imaging flow cytometer. In some embodiments, the first imaging device includes a particle motion assembly to allow a suspension including the particles to move along a travel path while being imaged by the first imaging device. The particle motion assembly may be configured to facilitate a sequential imaging of individual particles while the particles are traveling through the first imaging device. The particle motion assembly may include a flow focusing unit configured to focus the particles into a single-particle stream to be imaged sequentially. The single-particle stream may have a particle concentration of as low as 10 particles/μL to higher than 500 particles/μL. For example, the single-particle stream has a particle concentration of 10 particles/μL, 20 particles/μL, 40 particles/μL, 50 particles/μL, 60particles/μL, 80 particles/μL, 100 particles/μL, 150 particles/μL, 200 particles/μL, 300particles/μL, 400 particles/μL, 500 particles/μL, or higher than 500 particles/μL. The particle motion assembly may include a substrate on which the travel path is formed. For instance, there is a flow channel on the substrate that forms the travel path for the particles to move. Considering the ratio of the object particle count to the marker count as described elsewhere in the present disclosure, the single-particle stream may have an object particle concentration of, for example, 5 object particles/μL, 10 object particles/μL, 20 object particles/μL, 40 object particles/μL, 50 object particles/μL, 60 object particles/μL, 80 object particles/μL, 100 object particles/μL, 150 object particles/μL, 200 object particles/μL, 300 object particles/μL, 400 object particles/μL, 500 object particles/μL, or higher.

In some embodiments, the first imaging device may be operable to record multi-parameter particle images (e.g., 2D particle images and/or 3D particle images) of the particles travelling in the first imaging device at a throughput rate of 100 particles/second to higher than 1000 particles/second. For example, the throughput rate may be 200 particles/second, 300 particles/second, 500 particles/second, 600 particles/second, 800 particles/second, or 1000 particles/second, or higher. Considering the ratio of the object particle count to the marker count as described elsewhere in the present disclosure, the throughput rate of the object particles may be, for example, 50 object particles/second, 100 object particles/second, 200 object particles/second, 300 object particles/second, 500 object particles/second, 600 object particles/second, 800 object particles/second, or 1000 object particles/second, or higher.

In some embodiments, the first imaging device 110 may include an optical illumination assembly to produce a light beam to illuminate a particle in a light interrogation area while the particle travels through the first imaging device along a travel path. The travel path may traverse the light interrogation area. In some embodiments, the light interrogation area is an asymmetric illumination area of light. In some embodiments, the asymmetric illumination area of light may include one dimension of illumination different from the other dimension of illumination to form a shape like a two-dimensional illumination plane. In some embodiments, the first imaging device 110 may include an optical detection assembly to detect optical signal data of the particle generated based on the light beam. An example first imaging device 110 is illustrated in FIG. 1D.

In some embodiments, the first imaging data acquired by the first imaging device 110 may include first sequence information of a first sequence in which the particles are imaged in the first imaging device. The first imaging data may include information have single-particle resolution indicative of features of the individual particles. For instance, the first imaging device may include a 3D imaging flow cytometer as illustrated in FIG. 1D. The first imaging data acquired using the 3D imaging flow cytometer may include or be used to generate a 3D tomographic image, a 3D side scattering and fluorescent images, or a 2D transmission image for a particle travelling through the first imaging device 100. The first imaging data may include feature information indicative of particle features including, e.g., size, morphology, type, or the like, or a combination thereof. In some embodiments, the first sequence may include a first marker sequence according to which the first marker particles and the second marker particles are located in the first sequence.

In some embodiments, the particle dispensing assembly 120 may include a particle dispenser and a particle holder. The particle dispenser may be a robotic particle dispenser. The particle dispenser may be in communication with the first imaging device and operable to dispense the particles exiting the first imaging device to the particle holder at respective holder positions. In some embodiments, the particle dispenser may dispense the particles exiting the first imaging device to the particle holder in a substantially first-in-first-out manner to achieve one-to-one correspondence between individual particles recorded in the first imaging data acquired using the first imaging device (e.g., 3D cell images acquired using 3D-IFC) and the positions of the particles on the particle holder recorded in the second image data. As used herein, “substantially” indicates that the deviation in the particle dispensing from FIFO is below a threshold, e.g., below 50%, or 40%, or 30%, or 20%.

In some embodiments, the particle holder may include a sheet on which the particles are positioned. In some embodiments, the particle holder may include a plurality of wells. A particle that has exited the first imaging device may be placed in one of the plurality of wells. The surface of the particle holder (e.g., a sheet configuration, a multiple-well configuration) where the particles are placed may be particle friendly. For example, the particles include cells, and the surface of the particle holder may be cell-friendly. Merely by way of example, the surface of the particle holder may include a cell-friendly substrate.

In some embodiments, the holder positions of the particles may be arranged in an array. The array may include multiple rows. Each of at least some of the rows may include multiple particles. Each two neighboring rows of the multiple rows may be spaced apart by an inter-row spacing. The inter-row spacing may be selected based on one or more considerations including, e.g., a spatial resolution of the second imaging device. For example, the inter-row spacing may equal or exceed the spatial resolution of the second imaging device. As used herein, two rows are considered to be neighboring each other if there is no other row of particles between the two rows.

In some embodiments, two neighboring holder positions in a same row may be spaced by an intra-row spacing. The intra-row spacing may be selected based on one or more considerations including, e.g., a spatial resolution of the second imaging device. For example, the intra-row spacing may equal or exceed the spatial resolution of the second imaging device. As used herein, two particles or holder positions in a same row are considered to be neighboring each other if there is no other particle between the two particles. In some embodiments, the inter-row spacing may be the same as or different from the intra-row spacing.

In some embodiments, the particles may be mixed with liquid while traveling through the first imaging device 110. The liquid may provide lubrication for the particles, and/or drive the particles to travel through the first imaging device 110. In some embodiments, the particles include cells, and the liquid may keep the cells live and/or intact while the cells travel through the first imaging device 110. When the particles and the liquid exit the first imaging device 110, the particle holder may drain at least a portion of the liquid. In some embodiments, at least a portion of the liquid may be removed before the particles are placed in the particle holder (e.g., settled on a surface of the particle holder). In some embodiments, at least a portion of the liquid may be drained via, e.g., a filter, a porous substrate, after the liquid reaches the particle holder. Merely by way of example, at least a portion of the liquid may be drained via a porous member at a bottom of the particle holder driven by, e.g., gravity, and or suction using a vacuum. More description in this regard may be found elsewhere in the present disclosure. See, e.g., FIG. 1D and relevant description thereof.

In some embodiments, the second imaging device 130 is an optical microscope. For example, the second imaging device 130 is a low-resolution microscope, e.g., a microscope of 10× magnification power. The second imaging device 30 is operable to capture second imaging data of the particles when they are positioned at their respective holder positions. For instance, the particles exiting the first imaging device 110 may be imaged using the second imaging device 130 when they are positioned at respective holder positions. The second imaging data may include second sequence information of a second sequence of the particles corresponding to their respective holder positions in the particle holder. The second sequence may include a second marker sequence according to which the first marker particles and the second marker particles are located in the second sequence.

In some embodiments, the data processing device 140 may be in communication with one or more components of the system 100. For example, the data processing device 140 may be in communication with the first imaging device 110 and configured to process the first imaging data obtained by the first imaging device 110 and produce data including information indicative of features (e.g., 3D features) of individual particles that travel through and are imaged in the first imaging device 110. As another example, the data processing device 140 may be in communication with the second imaging device 130 and configured to process the second imaging data obtained by the second imaging device 130 and produce data including information indicative of features (e.g., holder positions) of individual particles positioned in respective holder positions of the particle holder. The data processing device 140 may perform additional data processing as described elsewhere in the present disclosure, and/or provide information for control the operation of the system 100. For example, the data processing device 140 may provide information for control the operation of the particle dispenser (e.g., its movement) so that the particles are dispensed to the particle holder at a desirable manner and/or the particles are spaced sufficiently based on one or more factors including, e.g., the spatial resolution of the second imaging device 130.

In some embodiments, the system 100 may omit one or more components shown in FIG. 1A. For example, the system 100 may omit the data processing device 140. Instead, the system 100 may be operably connected to an external data processing device for performing data processing based on relevant data, e.g., data acquired by one or more components of the system 100.

In some embodiments, the system 100 (e.g., the data processing device 140 of the system 100) may be operable to locate an object particle of the heterogeneous particle population by correlating, based on sequence information of the marker particles in the first sequence information and in the second sequence information, information of an object particle in the first imaging data with information of the object particle in the second imaging data. The identified object particle may be further processed as described elsewhere in the present disclosure.

In some embodiments, the system 100 may map the first sequence with the second sequence based on the first marker sequence and the second marker sequence, and correlate the information of the object particle in the first imaging data with information of the object particle in the second imaging data based on the mapping.

In some embodiments, the system 100 may map the first sequence with the second sequence based on the first marker sequence and the second marker sequence by performing one or more of the following operations. The system 100 may identify, in the first marker sequence, a first target marker pair including a marker particle A and a marker particle B that is positioned downstream of and next to the marker particle A in the first marker sequence. In some embodiments, the marker particle A and the marker particle B may be of a same marker type or of different marker type. The system 100 may identify, in the second marker sequence, a second target marker pair including a marker particle C and a marker particle D, in which the marker particle C is of a same type as the marker particle A, and the marker particle D is of a same type as the marker particle B and downstream of and next to the marker particle C in the second marker sequence. In some embodiments, the marker particle C and the marker particle D may be of a same marker type or of different marker type. The system 100 may determine, based on the first imaging data, a first particle count of particles located between the marker particle A and the marker particle B in the first sequence. In some embodiments, only object particles located between the marker particle A and the marker particle B in the first sequence are counted to obtain the first particle count. The system 100 may determine, based on the second imaging data, a second particle count of particles located between the marker particle C and the marker particle D in the second sequence. In some embodiments, only object particles located between the marker particle C and the marker particle D in the second sequence are counted to obtain the second particle count. In response to determining that the first particle count equals the second particle count, the system 100 may determine that a first target portion of the first sequence between the marker A and the marker B corresponds to a second target portion of the second sequence between the marker C and the marker D.

In some embodiments, images of individual particles may be generated based on the first imaging data. For instance, an image including one particle may be generated based on the first imaging data. In some embodiments, images of individual particles may be generated based on the second imaging data. For instance, an image including one or more particles may be generated based on the second imaging data; in the image, individual particles are spaced from each other due to, e.g., inter-row spacing, intra-row spacing between the holder positions of the particles. In some embodiments, multiple particles may appear clustered in an image. For instance, an image may include a representation of a doublet. Relevant portions of the first imaging data and/or the second imaging data may be analyzed to determine whether the representation corresponds to a single particle or multiple particles. For example, multiple images including, e.g., a 3D SSC image, a 3D fluorescent image, and 2D transmission image, may be generated for a particle of a cluster of particles (e.g., two particles clustered together) based on the first imaging data. A representation of a doublet in one of the images may be assessed in one or more other images to determine whether the representation corresponds to a single particle or a cluster of particles. In some embodiments, this operation may help improve the accuracy in determining the particle count of a string of particles in a sequence as described elsewhere with reference to, e.g., the mapping operation. In some embodiments, this operation may facilitate the identification of a multiple cell complex or cluster. For instance, this operation may facilitate the identification of a T-cell/cancer cell complex for T-cell receptor (TCR) and neoantigen detection, a step for CAR-T immunotherapy.

In some embodiments, the system 100 may identify an error portion of the first sequence or an error portion of the second sequence. In some embodiments, the error portion of the first sequence or the error portion of the second sequence may include a portion of the first or second sequence that is between a successfully registered pair of marker particles (or referred to as a target marker pair) but the particle count of particles between the two marker particles in the first sequence is different from the particle count of particles between the two corresponding marker particles in the second sequence. The system 100 may identify, in the first marker sequence, a first target marker pair including a marker particle A and a marker particle B that is positioned downstream of and next to the marker particle A in the first marker sequence. In some embodiments, the marker particle A and the marker particle B may be of a same marker type or of different marker type. The system 100 may identify, in the second marker sequence, a second target marker pair including a marker particle C and a marker particle D, the marker particle C being of a same type as the marker particle A, the marker particle D being of a same type as the marker particle B and downstream of and next to the marker particle C in the second marker sequence. The system 100 may determine, based on the first imaging data, a first particle count of particles located between the marker particle A and the marker particle B in the first sequence. In some embodiments, only object particles located between the marker particle A and the marker particle B in the first sequence are counted to obtain the first particle count. The system 100 may determine, based on the second imaging data, a second particle count of particles located between the marker particle C and the marker particle D in the second sequence. In some embodiments, the marker particle C and the marker particle D may be of a same marker type or of different marker type. In some embodiments, only object particles located between the marker particle C and the marker particle D in the second sequence are counted to obtain the second particle count. In response to determining that the first particle count is different from the second particle count, the system 100 may perform at least one of: determining that a first portion of the first sequence between the marker A and the marker B constitutes the error portion of the first sequence; determining that a second portion of the second sequence between the marker C and the marker D constitutes the error portion of the second sequence; or determining that the first portion does not correspond to the second portion.

In some embodiments, the error portion of the first sequence or the error portion of the second sequence may correspond to a deletion error or a misplacement error. A deletion error may occur due to, e.g., a marker particle imaged in the first imaging device 110 but is missing from the imaging of the particles in the particle holder using the second imaging device 130. A misplacement error may occur due to, e.g., a marker particle being misplaced. This is, a marker particle is imaged at a specific location as recorded in the first sequence or first marker sequence, but at a different location as recorded in the second sequence or second marker sequence. The system 100 may identify an error portion of a sequence (e.g., the first sequence, the second sequence) by identifying an error marker portion. The error marker portion may correspond to at least one of a deletion error or a misplacement error. The system 100 may identify, an error marker portion of the first marker sequence or of the second marker sequence. The error portion of a marker sequence (e.g., the first marker sequence, the second marker sequence) may include a marker particle E and a marker particle F in the first or second marker sequence. In some embodiments, the system 100 may identify an error portion of the first sequence including particles located between the marker particle E and the marker particle Fin the first sequence. In some embodiments, the system 100 may identify an error portion of the second sequence including particles located between the marker particle E and the marker particle F in the second sequence.

In some embodiments, the first marker sequence may include multiple first target marker pairs, and correspondingly the second marker sequence may include multiple second target marker pairs. In some embodiments, neighboring first target marker pairs of the first marker sequence may be continuous. In some embodiments, neighboring first target marker pairs of the first marker sequence may be spaced apart by, e.g., an error portion of the first marker sequence. In some embodiments, the first sequence may include multiple first target portions each of which corresponds to a second target portion of the second sequence. In some embodiments, neighboring first target portions of the first sequence may be continuous; corresponding neighboring second target portions of the second sequence may be continuous. In some embodiments, neighboring first target portions of the first sequence may be spaced apart by, e.g., an error portion of the first sequence; corresponding neighboring second target portions of the second sequence may be spaced apart by, e.g., an error portion of the second sequence.

In some embodiments, the system 100 may remove the error portion of a sequence (e.g., the first sequence, the second sequence) and/or an error marker portion of a marker sequence (e.g., the first marker sequence, the second marker sequence) from further analysis so that the error portion or the error marker portion is isolated and does not get promulgate in further analysis.

In some embodiments, if a section of the first sequence or the second sequence include error portions that exceed an error threshold, the system 100 may remove the entire section from further processing. For example, the system 100 may determine a ratio of the particle count of the particles belonging to any one of one or more error portions located within a specific section of the first sequence to a total particle count of all the particles located within the section; if the ratio exceeds a threshold, the system 100 may remove the entire section from further analysis.

In some embodiments, if a section of the first marker sequence or the second marker sequence include error portions that exceed an error threshold, the system 100 may remove the entire section of the first (or second) marker sequence, and/or the corresponding section in the first (or second) sequence from further processing. For example, the system 100 may determine a ratio of the particle count of the marker particles belonging to any one of one or more error portions located within a specific section of the first (or second) marker sequence to a total particle count of all the marker particles located within the section; if the ratio exceeds a threshold, the system 100 may remove the entire section of the first (or second) marker sequence from further analysis. Alternatively or additionally, the system 100 may remove a section of the first (or second) sequence that corresponds to the entire section of the first (or second) marker sequence from further analysis.

In some embodiments, the system 100 may assign a first nucleotide symbol to individual first marker particles and assign a second nucleotide symbol to individual second marker particles in the first marker sequence and also in the second marker sequence. Accordingly, the system 100 may perform an analysis on the first marker sequence and the second marker sequence, e.g., mapping, using a DNA sequencing algorithm.

FIG. 1B shows a block diagram of an example data processing device 140 of the example system 100. In various implementations, the data processing device 140 is embodied on one or more personal computing devices, e.g., including a desktop or laptop computer, one or more computing devices in a computer system or communication network accessible via the Internet (referred to as “the cloud”) including servers and/or databases in the cloud, and/or one or more mobile computing devices, such as a smartphone, tablet, or wearable computer device including a smartwatch or smartglasses. The data processing device 140 includes a processor to process data, and memory in communication with the processor to store and/or buffer data. For example, the processor can include a central processing unit (CPU) or a microcontroller unit (MCU). In some implementations, the processor can include a field-programmable gate-array (FPGA) or a graphics processing unit (GPU). For example, the memory can include and store processor-executable code, which when executed by the processor, configures the data processing device 140 to perform various operations, e.g., such as receiving information, commands, and/or data, processing information and data, such as from the system 100, and transmitting or providing processed information/data to another device, such as an actuator or external display. To support various functions of the data processing device 140, the memory can store information and data, such as instructions, software, values, images, and other data processed or referenced by the processor. For example, various types of Random Access Memory (RAM) devices, Read Only Memory (ROM) devices, Flash Memory devices, and other suitable storage media can be used to implement storage functions of the memory. In some implementations, the data processing device 140 includes an input/output (I/O) unit to interface the processor and/or memory to other modules, units or devices. In some embodiments, such as for mobile computing devices, the data processing device 140 includes a wireless communications unit, e.g., such as a transmitter (Tx) or a transmitter/receiver (Tx/Rx) unit. For example, in such embodiments, the I/O unit can interface the processor and memory with the wireless communications unit, e.g., to utilize various types of wireless interfaces compatible with typical data communication standards, which can be used in communications of the data processing device 140 with other devices, e.g., such as between the one or more computers in the cloud and the user device. The data communication standards include, but are not limited to, Bluetooth, Bluetooth low energy (BLE), Zigbee, IEEE 802.11, Wireless Local Area Network (WLAN), Wireless Personal Area Network (WPAN), Wireless Wide Area Network (WWAN), WiMAX, IEEE 802.16 (Worldwide Interoperability for Microwave Access (WiMAX)), 3G/4G/LTE/5G cellular communication methods, and parallel interfaces. In some implementations, the data processing device 140 can interface with other devices using a wired connection via the I/O unit. The data processing device 140 can also interface with other external interfaces, sources of data storage, and/or visual or audio display devices, etc. to retrieve and transfer data and information that can be processed by the processor, stored in the memory, or exhibited on an output unit of a display device or an external device.

FIG. 1C shows a flowchart of an example process 160 for processing a heterogeneous particle population. At 160-10, the system 100 may obtain first imaging data of particles of the heterogenous particle population captured by a first imaging device (e.g., the first imaging device 110 as illustrated in FIG. 1A, the 3D IFC as illustrated in FIG. 1D) upon the particles travelling through the first imaging device.

In some embodiments, the heterogeneous particle population may include particles of various types. In some embodiments, the heterogeneous particle population may include object particles and marker particles. In some embodiments, the object particles may include first object particles of a first particle type. In some embodiments, the marker particles may include first marker particles of a first marker type and second marker particles of a second marker type. The first marker particles and the second marker particles may have features that are distinguishable based on the first imaging data acquired using the first imaging device 110 and/or based on the second imaging data acquired using the second imaging device 130. For instance, individual first marker particles may have a size that is different from individual second marker particles. Merely by way of example, individual first marker particles may have a diameter of 10 micrometers, and individual second marker particles may have a diameter of 20 micrometers. In some embodiments, the heterogenous particle population may further include second object particles of a second particle type different from the first particle type. For instance, the first object particles may include cells from one or more samples with a pathological condition; and the second object particles may include cells from one or more samples with a control condition. In some embodiments, a ratio of the object particle count of the object particles in the heterogenous particle population to the marker count of the marker particles in the heterogenous particle population may be selected based on one or more considerations including, e.g., chances of error (as described elsewhere in the present disclosure), efficiency, etc., as described elsewhere in the present disclosure. In some embodiments, the particles may be pre-mixed before being fed to the first imaging device. In some embodiments, the particles may be fed to and get mixed in the first imaging device.

The first imaging data may include raw imaging data acquired by the first imaging device, images or data obtained by processing the raw imaging data, or the like, or a combination thereof. In some embodiments, the first imaging device may include a particle motion assembly. The particle motion assembly may be configured to facilitate a sequential imaging of individual particles while the particles are traveling through the first imaging device. For example, the particle motion assembly may include a flow focusing unit configured to focus the particles into a two-dimensional (2D) hydrodynamically focused single-particle stream to travel through the first imaging device and be imaged sequentially. The first imaging device may capture the first imaging data by illuminating the single-particle stream.

The first imaging data may also include feature information of the particles with single particle resolution. For instance, the first imaging data may include information indicative of the size, the morphology, etc., of individual particles. The first imaging data may include first sequence information of a first sequence in which the particles are imaged in the first imaging device. The first sequence may include a first marker sequence according to which the first marker particles and the second marker particles are located in the first sequence.

In some embodiments, the system 100 may assign nucleotide symbols to marker particles of different type. For example, the system 100 may assign a first nucleotide symbol to each first marker particle in the first sequence and a second nucleotide symbol to each second marker particle in the first sequence. Accordingly, the first sequence and the first marker sequence may be analyzed using a DNA sequencing algorithm.

At 160-20, the system 100 may obtain second imaging data of the particles captured using a second imaging device (e.g., the second imaging device 130 as illustrated in FIG. 1A) when the particles are dispensed to their respective holder positions in a particle holder. The second imaging data may include second sequence information of a second sequence of the particles corresponding to their respective holder positions in the particle holder. The second sequence may include a second marker sequence according to which the first marker particles and the second marker particles are located in the second sequence.

In some embodiments, the system 100 may assign nucleotide symbols to marker particles of different type in the second sequence in a same manner as in the first sequence. For example, the system 100 may assign the same first nucleotide symbol to each first marker particle in the second sequence and the same second nucleotide symbol to each second marker particle in the second sequence as in the first sequence. Accordingly, the second sequence and the second marker sequence may be analyzed using a DNA sequencing algorithm.

In some embodiments, the particles exiting the first imaging device may be dispensed, using a particle dispenser in communication with the first imaging device, to at their respective holder positions in the particle holder. The particle dispenser may dispense the particles exiting the first imaging device proceeds in a substantially first-in-first-out manner such that one-to-one correspondence between particles being imaged and particles being dispensed to their respective holder positioned may be preserved and recorded in the first imaging data and the second image data.

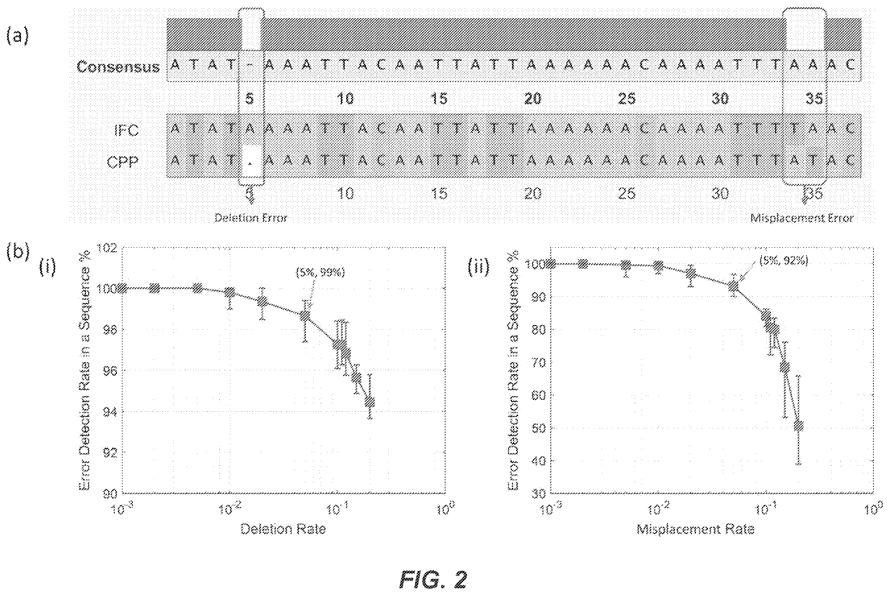

At 160-30, the system 100 may locate an object particle of the heterogenous particle population by correlating information of the object particle in the first imaging data with information of the object particle in the second imaging data. In some embodiments, the system 100 may map the first sequence with the second sequence based on the first marker sequence and the second marker sequence. The system 100 may use a DNA sequencing algorithm to analyze the first marker sequence and the second marker sequence to perform the mapping. More description regarding the mapping may be found elsewhere in the present disclosure. See, e.g., FIG. 1A, FIG. 1D, FIGS. 2-6, and relevant description thereof. The system 100 may correlate, based on the mapping, the information of the object particle in the first imaging data with the information of the object particle in the second imaging data. More description regarding the correlation may be found elsewhere in the present disclosure. See, e.g., FIG. 1A, FIG. 1D, FIGS. 2-6, and relevant description thereof.

In some embodiments, to map the first sequence with the second sequence based on the first marker sequence and the second marker sequence, the system 100 may identify an error portion of the first sequence or an error portion of the second sequence as described elsewhere in the present disclosure. The error portion may occur due to, e.g., a deletion error and/or a misplacement error. In some embodiments, such an error portion in a sequence, or a section enclosing one or more such error portions, may be disregarded from further analysis. See, e.g., FIG. 1A and relevant description thereof.

In some embodiments, the system 100 may generate a particle map by processing the heterogenous particle population. The particle map may link information of individual particles from the first imaging data with that from the second imaging data. For example, the particle map may include the respective holder positions from the second imaging data and information of the particles from the first imaging data of individual particles of the heterogenous particle population. To generate the particle map, the system 100 may, for each of multiple object particles of the heterogenous particle population, locate the object particle by correlating information of the object particle in the first imaging data and information of the object particle in the second imaging data. The correlation may be performed as described above. In some embodiments, an object particle may be located by determining its holder position.

Based on the correlation, a portion of the first imaging data relating to a specific particle and a portion of the second imaging data relating to the same particle may be identified and pooled. For instance, a portion of the first imaging data relating to a specific particle indicates that the particle is a cell of interest (e.g., a cancer cell, a cell from a subject with a pathological condition of interest) and a portion of the second imaging data relating to the same particle informs its holder position in the particle holder; based on the combined information, the cell of interest may be picked up for further processing including, e.g., culturing, genetic sequencing, staining, imaging, metabolic analysis, or the like, or a combination thereof.

For example, cells of a specific type (e.g., cancer cells of a specific type, cells from one or more subjects with a pathological condition of interest) may be picked up from their respective holder positions and pooled and cultured. As another example, cells of a specific type (e.g., cancer cells of a specific type, cells from one or more subjects with a pathological condition of interest) may be cultured in situ in their respective holder positions (e.g., the particle holder including multiple wells each holding a cell), their secretion may be collected and analyzed individually, or pooled and analyzed (e.g., using a metabolic analysis assay). As a further example, one or more cells of a specific type may be picked up from the holder position(s) and cultured to grow a microcolony. As still a further example, the particle holder includes a sheet on which the particles are positioned; particles other than the cells of interest may be located and removed from the sheet based on the particle map; and at least one of the cells of interest may be cultured by placing the sheet, or a portion thereof, including at least one of the cells of interest in a cell culture medium.

FIG. 1D shows diagrams illustrating an example system 170 for processing a heterogenous particle population by mapping particle images to particle positions. The diagrams depict an example design and workflow of the system 100. The system 170 includes two interconnected hardware modules, a 3D imaging flow cytometer 170-10 illustrated in panel (i) and a cell placement platform 170-20 as illustrated in panel (ii). The cell placement platform 170-20 includes a particle holder 170-26. The 3D IFC 170-10 provides an example of the first imaging device 110. In the example system 170, the cell placement platform 170-20 is a robotic cell dispenser. The cell placement platform 170-20 provides an example of the particle dispenser of the particle dispensing assembly 120. The sample holder 170-26 of the cell placement platform 170-20 provides an example of the particle holder of the particle dispensing assembly 120.

As illustrated in panel (i) of FIG. 1D, three types of cells and three types of marker beads may be pre-mixed and examined using the 3D-IFC 170-10. The hydrodynamically focused sample flow establishes a single-cell stream with a sample concentration of, e.g., ˜500 particles/uL. When a particle (e.g., a cell or marker bead) passes through a light interrogation area 170-14 (e.g., a laser interrogation area), it is illuminated by a scanning light sheet at a scanning rate (e.g., a 200 kHz). The scanning light sheet is a substantially two-dimensional area with scanning light (e.g., laser). For instance, the scanning light sheet may include an asymmetric illumination area of light as described elsewhere in the present disclosure. A spatial filter placed at the image plane (e.g., the scanning light sheet) contains a series of spatially positioned apertures (e.g., pinholes, slits) aligned with the cell flow direction by a predetermined separation. The emitted light from a specific portion of a cell is detected by photodetectors (e.g., photomultiplier tubes (PMTs)). The photodetectors may be single-element photodetectors to detect the fluorescence optical signal that has traversed the spatial filter in each signal channel. The 3D-IFC 170-10 integrates the scanning light sheet, the cell's flow motion, and the spatial filter, such that the photodetectors are operable to detect an individual point in the particle at a time, which allows space-to-time mapping on a one-to-one basis, so called spatial-to-temporal transformation.

The spatial-temporal transformation is applied to reconstruct the 3D tomographic images. The forward spatial filter contains a long slit aligned with the laser scanning range. The transmitted light is collected by a PMT and the signal can produce a 2D transmission image. In this cameraless design with a scanning light-sheet and spatial filters (or referred to as spatial masks), the 3D-IFC 170-10 can produce 3D side scattering and fluorescent images plus a 2D transmission image of traveling cells at a rate of, e.g., 1000 cells/s. Some examples of features for embodiments of the 3D-IFC 170-10 can be found in U.S. Pat. No. 11,371,929, titled “Systems, Devices and Methods for Three-Dimensional Imaging of Moving Particles,” which is included as part of the disclosure of this patent document.

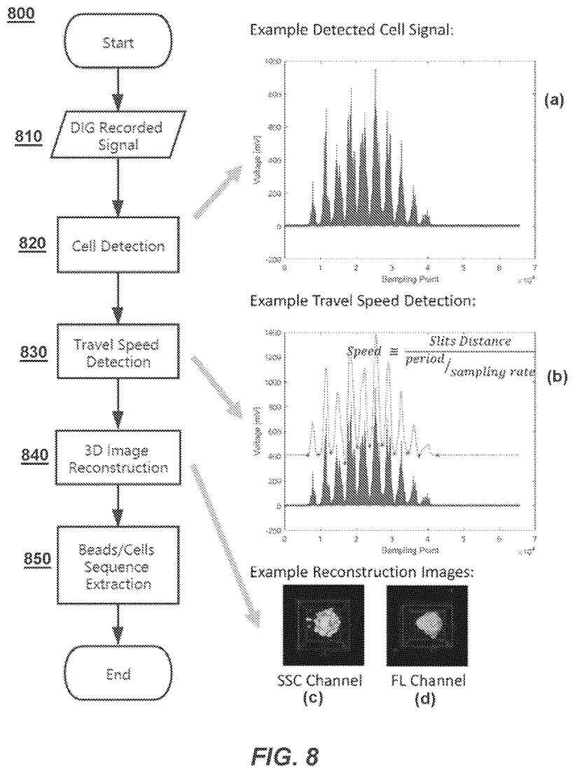

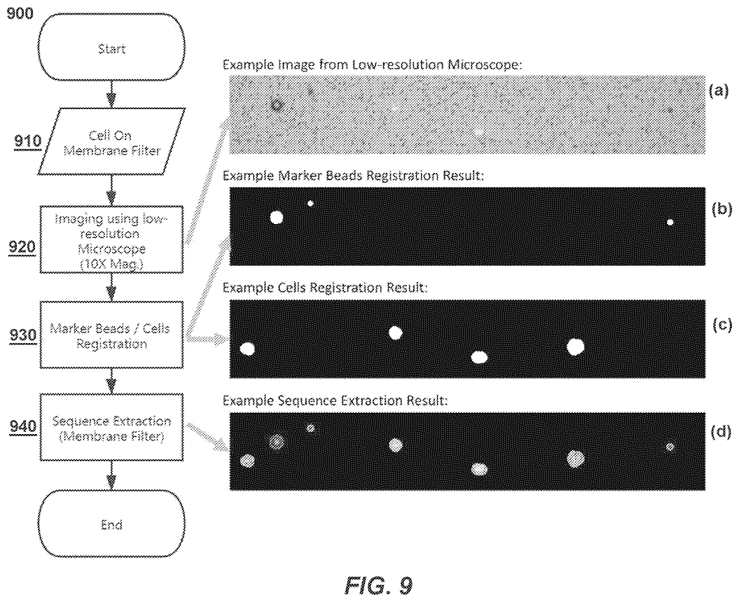

The diagram of FIG. 1D illustrates an example cell analysis and isolation workflow based on 3D imaging flow cytometer (3D-IFC) 170-10 and robotic cell dispensing and pickup. A sample is formed by mixing particles of different types, including three types of marker beads (or referred to as marker particles) and three types of cells (or referred to as object particles). The three types of marker beads include 30-micrometer marker beads, 20-micrometer marker beads, and 10-micrometer marker beads. The three types of cells include cells of Cell Type #1, cells of Cell Type #2, and cells of Cell Type #3. For illustration purposes and not intended to be limiting, the workflow illustrated in FIG. 1D includes the following. (i) Three types of marker beads are mixed with a cell mixture to help map cell images from the image stream to cell locations. The sample runs through a 3D-IFC that can capture 3D fluorescent and side-scattering (SSC) images as well as 2D cell transmission images. (ii) After cells exit the 3D-IFC 170-10, they are dispensed by a robotic dispenser 170-20 in a first-in-first-out (FIFO) manner on a template. (iii) The system 170 extracts sequences (including both cells and marker beads), including marker sequences (including only marker beads), from signals from the 3D-IFC 170-10 and the cell placement platform (CPP) 170-20 using sequence extraction pipelines described elsewhere in the present disclosure. See, e.g., FIG. 8 and FIG. 9. The 30-micrometer marker beads, 20-micrometer marker beads, and 10-micrometer marker beads are denoted as C, T, and A, respectively, in the sequences, including the marker sequences. (iv) The system 170 compares and matches the two sequences using a sequencing bioinformatics tool. (v) The system 170 checks for marker sequence errors (including deletion and misplacement errors), and for the successfully registered marker beads (or referred to as a target marker pair), the number of cells (or referred to as particle count) between two marker beads of the target marker pair is determined. In this manner, hundreds of thousands of individual cells may be related to their respective 3D fluorescent and scattering images in high accuracy. If certain cells with specific image features are of interest, those cells may be located and/or picked up individually for downstream analyses.

In FIG. 1D, the following labels include: AOD, acousto-optic deflector; CL, cylindrical lens; IO, 20×/0.42 illumination objective; SDO, 10×/0.28 side detection objective; SSP, side spatial filter; DMs, dichroic mirrors; FDO, forward detection objective; FSP, forward spatial filter; PMT, photomultiplier tube; DIG, 125 MSs-1 digitizer; SE1, Sequence Extraction from 3D-IFC, SE2: Sequence Extraction from cell placement platform (CPP).

The robotic cell placement platform 170-20 contains a particle dispenser 170-20 that includes a three-axis motorized stage and a holder 170-26. The moving speed of the motorized stage is programmable to control the cell to cell spacing and can be up to 75 mm/s. The particles (e.g., cells, marker beads) exiting the 3D-IFC 170-10 reside on a transparent porous film on the sample holder 170-26 that has an array of groves connected to a vacuum pump. The liquid out of the 3D-IFC 170-10 is absorbed by the porous membrane filter through the capillary effect, and the extra liquid is drained by vacuuming the groves under the membrane.

The cell sample is premixed with three non-fluorescent beads of different sizes: 10-micrometer marker beads represented as nucleobase A, 20-micrometer marker beads represented as nucleobase T, and 30-micrometer marker beads represented as nucleobase C. Hence the sequence includes these 3 types of marker beads and cells. By matching the marker bead sequences recorded in the 3D-IFC signals acquired in the 3D-IFC 170-10 and the signals acquired in the cell placement platform 170-20, the two sequences may be aligned or mapped, which subsequently allows for mapping the cells between marker beads. To keep the average number of cells between marker beads to be a relatively small number (e.g., n=2) and minimize or reduce the chance of error, the ratio of a cell count of the cells to a marker count of the marker beads may be set to below 10:1. For example, the ratio may be 8:1, 5:1, 3:1 or 2:1.

As illustrated in panel (i) of FIG. 1D, the particles including the cells and marker beads pass through a flow focusing unit 170-12 to be focused by a sheath into a two-dimensional (2D) hydrodynamically focused single-particle stream, pass the laser interrogation area 170-14 of the 3D-IFC 170-10 to be imaged, and exit the 3D-IFC 170-10. As illustrated in panel (ii) of FIG. 1D, the particles exiting the 3D-IFC 17-10 are dispensed in a first-in-first-out (FIFO) manner on a template of the sample holder 170-26 of the cell placement platform 170-20. Merely by way of example, the template may include a 12-micrometer thick transparent porous film on a holder 170-26 with an array of groves. The liquid out of the 3D-IFC 170-10 (at around 300 μL/min) may be absorbed by the porous membrane filter through the capillary effect and drained by vacuuming the groves under the membrane. The marker beads and cells are left on the wetted porous membrane. The moving speed of the template of the sample holder 170-26 is programmed according to the cell density in the sample being dispensed to achieve an average cell-to-cell spacing of 250 micrometers along the line of travel (corresponding to the intra-row spacing described elsewhere in the present disclosure) and a spacing of 500 micrometers between two adjacent lines of cells (corresponding to the inter-row spacing described elsewhere in the present disclosure). In this example design, a filter plate of the same size of a 384-well plate can house around 6×104 cells. For a 30-minute test run of the 3D-IFC 170-10 at a throughput of 300 cells/s, the system 170 recorded around 500,000 3D images of single cells deposited on the sample holder 170-26 including 10 cell plates with full knowledge of the position of every single cell and its IFC image(s).

FIG. 2 shows a diagram and data plots illustrating example sequence matching results from example implementations of the example system 170 illustrated in FIG. 1D. Panel (a) of FIG. 2 shows example sequence matching results of the marker beads readout by the 3D-IFC 170-10 and the CPP 170-20 using a bioinformatics toolbox in MATLAB; Panel (b) of FIG. 2 shows example data plots of Monte Carlo simulated error detection probability versus error rate due to (i) deletion (a marker bead is missing) and (ii) misplacement (a marker bead is misplaced). Here 10-μm marker beads are represented by “A,” 20-μm marker beads by “T,” and 30-μm marker beads by “C.”

A bioinformatics toolbox may be used to match the bead sequences (or referred to as marker sequence) of the readout of the 3D-IFC 170-10 and the cell placement platform 170-20, which is equivalent to comparing 2 “DNA” sequences. The system 170 matches the marker beads between the two sequences (e.g., by comparing the two bead sequences) and then matches the cells in the two sequences (e.g., each of the two sequences including both cells and marker beads) between successfully registered marker beads (or referred to as a target marker pair). An example of the matching result of the marker beads is shown in panel (a) of FIG. 2. The consensus map in panel (a) of FIG. 2 shows that errors can be detected and located. Errors can be caused by marker bead/cell trapping within the system 170 (equivalent to deletion error) or misplacement (e.g., violating the FIFO rule). In an example run, one deletion error (in the 5th position) and one misplacement error (in the 34th position) were identified as illustrated in panel (a) of FIG. 2.

If the system 170 identifies an error in a marker sequence (e.g., an error in the marker sequence corresponding to a deletion error, an error in the sequence corresponding to a misplacement error, or any combination thereof), the system 170 may skip the cells following the erroneous marker beads in further analysis. Such an error in the marker sequence may be indicated by an error marker pair including two neighboring marker particles in the marker sequence. In some embodiments, the system 170 may skip all the cells in the sequence that are between the marker beads of the error marker pair. In some embodiments, the system 170 may skip all the cells in the sequence that are between the marker beads of the error marker pair and some additional cells preceding and/or following these cells. Merely by way of example, the system 170 may skip all the cells between the marker beads of an error marker pair and cells between the marker beads of a neighboring marker pair that contains no error, in which the error marker pair and the neighboring marker pair are next to each other in the marker sequence such that no other marker pair is located between the error marker pair and the neighboring marker pair in the marker sequence. By disregarding the cells in a sequence between marker beads of an error marker sequence, and in some embodiments additional cells in a vicinity of the cells, the system 170 may improve accuracy of the mapping and subsequent analysis. By checking errors in the marker sequence and/or in the full sequence including the cells and the marker beads, and disregarding a portion of the marker sequence or the full sequence from further analysis, the system 170 may minimize or reduce the probability of assigning wrong images to the cells. In some embodiments, the system 170 may relate cell images to >80% of the cells in an original sample (e.g., a sample of a heterogenous particle population) with high confidence, dropping about 15-20% of cells due to deletion or misplacement errors.

Simulation results may be generated to show how the bioinformatics software can detect deletion and misplacement errors and how the error detection capability changes with the frequency of these errors. Panels (b) and (c) of FIG. 2 show Monte Carlo simulations of the dependence of error detection capability on the error occurring frequency for both deletion errors and misplacement errors. In the simulations, it was assumed that the first DNA sequence contained 3 types of nucleotides for a total length of 10,000 nucleotides. A second DNA sequence may be generated using the first one as a template, but some nucleotides are deleted or misplaced at given error rates (e.g., randomly deleted 100 from 10,000 nucleotides for a 1% deletion rate). Two sequences of DNAs may be matched using the bioinformatics toolbox. The simulations show that for a 5% probability of deletion error, 99% of the errors may be successfully located. For a 5% probability of misplacement error, 92% of the errors may be successfully located. If the probability of both types of errors is within 1% (i.e., less than 100 deletion or misplacement errors in a sequence of 10,000 nucleotides), all errors may be detected. For those regions of high deletion and misplacement errors that led to lower than a threshold confidence level, all cells in those regions and their corresponding images may be disregarded.

### Experiment with Mixture of Marker Beads and Fluorescent Signal Beads

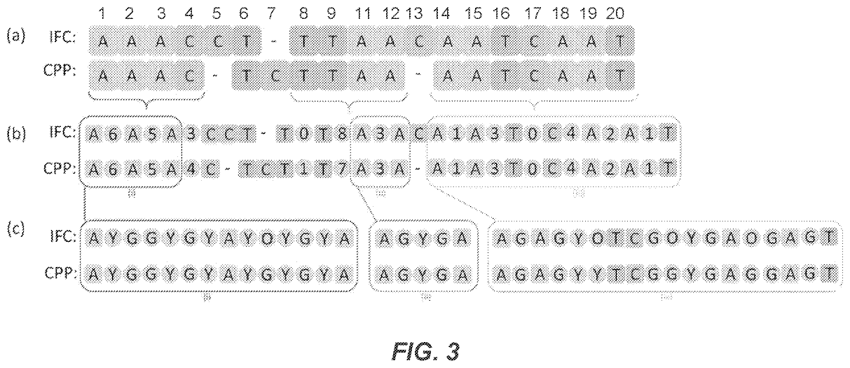

FIG. 3 shows diagrams illustrating example results from example experiments using fluorescent beads (Y: envy green and G: dragon green) mixed with marker beads of three marker types (A, T, C). Here 10-μm marker beads are represented by “A,” 20-μm marker beads by “T,” and 30-μm marker beads by “C.” Panel (a) of FIG. 3 shows matching results of the marker sequences from the 3D-IFC readout and CPP readout using Bioinformatics toolbox in MATLAB. Panel (b) of FIG. 3 shows a map including the number of fluorescent beads between correctly identified marker beads. Panel (c) of FIG. 3 shows a readout of the fluorescent beads (Y, G) between marker beads (A, T, C). As illustrated in panel (c) of FIG. 3, besides Y and G, “O” represents beads of which the 3D-IFC images are out of focus. In other words, even if the bead can be identified, its image is too blur to extract useful information (e.g., morphological information) of the cell represented in the image.

The matching results shown in panel (a) of FIG. 3 were obtained based on a sample generated by mixing two types of fluorescent polystyrene beads (10 um Dragon Green and 10 um Envy Green from Bangs Laboratories) with the marker beads in a 2:1 ratio. The two sequences (the IFC sequence and the CPP sequence illustrated in panel (a) of FIG. 3) were extracted from the imaging data acquired by 3D-IFC 170-10 and the imaging data acquired by the CPP 170-20, the bioinformatics toolbox in MATLAB was employed to match the two sequences. Panel (a) of FIG. 3 shows a section of the matched sequences. This section includes one misplacement error (i.e. the marker bead “C” is misplaced from the 5th position to the 7^{th} position in the CPP) and one deletion error (in the 13th position) in the CPP sequence illustrated in panel (a) of FIG. 3.

Panel (b) of FIG. 3 lists the number of fluorescent beads between each pair of marker beads. Panel (c) of FIG. 3 shows the actual readouts of the fluorescent beads to be envy green (Y) or dragon green (G). In addition of symbols Y and G, another symbol “O” may be introduced to denotes those objects whose IFC images are out-of-focus. Due to imperfect flow confinement that may exist in the 3D-IFC 170-10, some particles (e.g., cells, marker beads) may deviate from the center of the cuvette (e.g., the light interrogation area of the first imaging device 110) to produce out-of-focused images. Combining all these factors, including deletion and misplacement of marker beads and fluorescent beads and out-of-focused images, at least 50% (e.g., 50%, 60%, 70%, or 80%) of the cells in a sample may be accurately processed such that the imaging data from the 3D IFC 170-10 and the imaging data from the CPP 170-20 may be correlated.

The present technology may be employed to map 3D images of labeled and unlabeled cells to their holder positions. Example methods for preparing the samples are described below. An example test sample contained a mixture of human embryonic kidney 293 cells (HEK-293), Michigan Cancer Foundation-7 cells (MCF-7), and cervical cancer cells (HeLa) in an approximately 1:1:1 ratio. MCF-7 cells and HeLa cells were fluorescently stained with the carboxyfluorescein succinimidyl ester (CFSE) (Ex/Em 492/517 nm, Thermo Fisher) and the CellTrace Yellow Proliferation Kit (Ex/Em 546/579 nm, Thermo Fisher), respectively. The HEK-293 cells were unstained.

In an example implementation, an example test sample flowed through and was imaged in the 3D-IFC 170-10 for high throughput imaging, and then the cells and marker beads were dispensed onto a membrane filter (e.g., a particle holder as described with reference to FIG. 1A) by a robotic cell dispenser of the cell placement platform 170-20 in a FIFO manner. The marker sequences of marker beads extracted from the imaging data acquired by the 3D-IFC 170-10 and from the imaging data acquired by the CPP 170-20 were first matched using the bioinformatics toolbox of MATLAB to identify target marker pairs and excluded those mismatched marker beads due to deletion or misplacement errors. Next, for a target marker pair, a first cell count of the cells between the two neighboring marker beads of the target marker pair recorded in the imaging data acquired by the 3D-IFC 170-10 (e.g., in the IFC sequence recorded in the imaging data acquired by the 3D-IFC 170-10) and a second cell count of the cells between the two neighboring marker beads of the target marker pair recorded in the imaging data acquired by the CPP 170-20 (e.g., in the CPP sequence recorded in the imaging data acquired by the CPP 170-20) were determined and compared. In response to determining that the first cell count and the second cell count were different, the section of the IFC sequence (or the CPP sequence) between the two neighboring marker beads of the target marker pair were disregarded. In response to determining that the first cell count and the second cell count were the same, the section of the IFC sequence (or the CPP sequence) between the two neighboring marker beads of the target marker pair were marked accordingly.

### Tracking 3D Cell Images and Their Positions

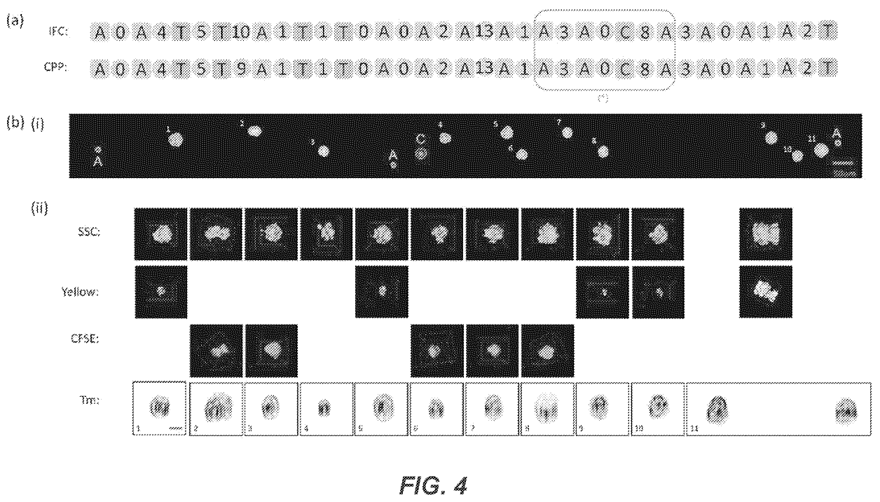

FIG. 4 shows diagrams illustrating example results from a heterogenous particle population including human cancer cells. MCF-7 and HeLa cells were stained with CFSE and CellTrace Yellow, respectively, and HEK-293 cells were unstained. The heterogenous particle population included marker beads of three marker types (A, T, C). Here 10-μm marker beads are represented by “A,” 20-μm marker beads by “T,” and 30-μm marker beads by “C.”

Panel (a) of FIG. 4 shows a representative section of each of two matched IFC and CPP sequences. The IFC sequence may be determined based on imaging data acquired using the 3D-IFC 1270-10. The CPP sequence may be determined based on imaging data acquired using the CPP 1270-20. The number shown between a pair of neighboring marker beads in a sequence (e.g., the IFC sequence, the CPP sequence) indicates the number of cells (or cell count) of a portion of the sequence between the pair of neighboring marker beads. When the cell counts of the corresponding portions in the two sequences are the same, the system 170 determines that the two portions in the two sequences correspond to each other. Accordingly, the imaging date of the individual cells within the portion acquired by the 3D-IFC 170-10 can be correlated to the imaging data of the same cells acquired by the CPP 170-20; that is, for the individual cells in the portion their imaging data from the 3D-IFC 170-10 and their imaging data from the CPP 170-20 may be correlated.

Panel (b) of FIG. 4 shows a representative section (in the box denoted by “*” in panel (a)) of marker beads and cells (i) on the CPP membrane and (ii) having their 3D SSC images and transmission images (in yellow and green from CFSE), as well as 2D transmission images. Cell #2 appears to be a doublet. Cell #11 shows a doublet in the scattering and fluorescent images, but the 2D transmission image can resolve the doublet from the perspective. CFSE stands for carboxyfluorescein succinimidyl ester Cell Proliferation Kit, Ex/Em, 488/517; Yellow stands for CellTrace Yellow Proliferation Kit, Ex/Em, 546/579; SSC involves 90 degrees side scattering; Tm stands for transmission image; the scale bar in panel (b) (i) represents 50 micrometers.

The built-in camera in the robotic cell placement platform 170-20 may have a large field of view but low resolution as its purpose is to simply identify the positions of marker beads and cells. Aided by image processing algorithms, the low-resolution camera images may distinguish marker beads by their size and register cells with their holder positions (expressed in the form of, e.g., location coordinates), which may be later used for targeted cell identification, pickup, and/or one or more other operations. The image processing algorithm may distinguish marker beads and cells from the background patterns of the pores on the filter surface of the particle holder of the CPP 170-26.

With the cell mapping capabilities of the present technology, one or more images (e.g., a 3D image, 2D transmission image) of each cell may be recorded and the position information (in the form of e.g., location coordinates) of the cell in the particle holder of the cell placement platform 170-20 may be determined for retrieval and/or one or more other applications including, e.g., molecular analysis or cell-based assay. In FIG. 4, cell #2 appears to be a doublet, as shown from its SSC and CFSE fluorescent images, as well as its 2D transmission image. However, cell #11 shows a doublet in its SSC and yellow fluorescent images but not in its 2D transmission image from the perspective. This example shows that 2D images may run into the issues of occlusion and perspective compared with 3D tomography.

### Separating Breast Cancer Cells from Normal Cells

In some embodiments, cells of a first type in a heterogenous cell population may be identified and located. In an example implementation involving identification and location of human breast cancer cells (MCF-7) from human breast epithelial cells (MCF-10A) may be achieved by correlating their holder positions with their images that include feature information. The MCF-7 cells were fluorescently stained with the CFSE Cell Proliferation Kit, and MCF-10A cells were not stained. Fluorescently label MCF-7 cells were used to establish the ground truth for verification. The heterogenous particle population included marker beads of three marker types (A, T, C). Here 10-μm marker beads are represented by “A,” 20-μm marker beads by “T,” and 30-μm marker beads by “C.” After capturing the imaging data of individual cells by the 3D-IFC 170-10 at a rate of 300 cells/s, cells were dispensed on the membrane in a FIFO manner.

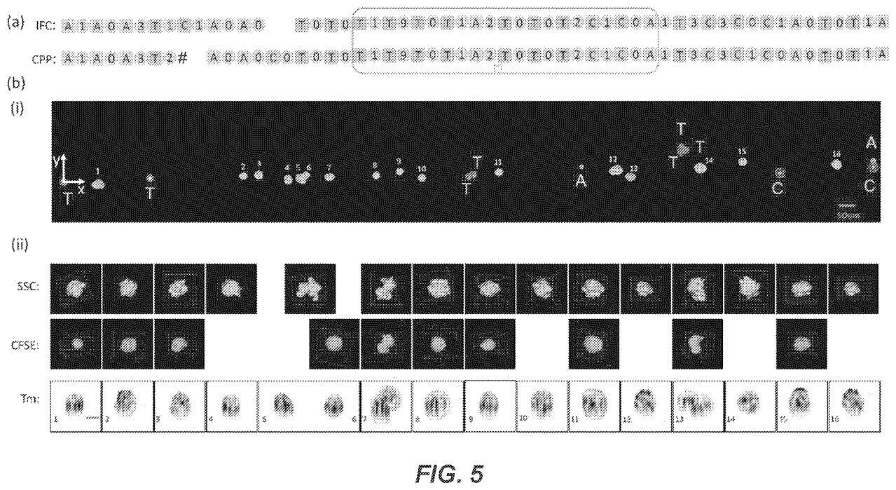

FIG. 5 shows diagrams illustrating example results from breast cancer cells. Panel (a) of FIG. 5 shows a representative section of the matched IFC and CPP sequences. The IFC sequence may be determined based on imaging data acquired using the 3D-IFC 1270-10. The CPP sequence may be determined based on imaging data acquired using the CPP 1270-20. The number shown between a pair of neighboring marker beads in a sequence (e.g., the IFC sequence, the CPP sequence) indicates the number of cells (or cell count) of a portion of the sequence between the pair of neighboring marker beads. When the cell counts of the corresponding portions in the two sequences are the same, the system 170 determines that the two portions in the two sequences correspond to each other. Accordingly, the imaging date of the individual cells within the portion acquired by the 3D-IFC 170-10 can be correlated to the imaging data of the same cells acquired by the CPP 170-20; that is, for the individual cells in the portion, their imaging data from the 3D-IFC 170-10 and their imaging data from the CPP 170-20 may be correlated.

Panel (b) of FIG. 5 shows a representative section (in the box denoted by “*” in panel (a)) of marker beads and cells including (i) on the CPP membrane and (ii) having their 3D SSC images and transmission images (in green from CFSE), as well as 2D transmission images. Panel (b)(i) of FIG. 5 shows low-resolution camera images for marker beads and cells on the membrane filter of CPP 170-20. The image resolution is sufficient for identification of the marker beads and the position information (e.g., location coordinates) of the cells as indicated in Table 1.

Panel (b)(ii) of FIG. 5 shows high resolution 3D SSC and fluorescent images and 2D transmission images of MCF-7 (CFSE stained) and MCF-10A (unstained) cells from the 3D-IFC 170-10. The 3D-IFC images can be employed to detect cell doublets (cell #7 and cell #13). For cell #7, the doublet includes an MCF-7 (fluorescent) and an MCF-10A (non-fluorescent) cell. For cell #13, the doublet includes two MCF-7 (fluorescent) cells. The scale bar in panel b (i) of FIG. 5 represents 50 micrometers.

The example data illustrated in panel (a) of FIG. 5 shows the sequence of marker beads and the cell numbers between a pair of two neighboring marker beads. Correlation between the 3D-IFC images of a cell and the position of the cell in the particle holder may be obtained except a single misplacement of the marker bead C as denoted by “#” in the CPP sequence in panel (a) of FIG. 5. The cells on the membrane and their corresponding 3D images in the matched sections within the highlighted box denoted by “*” in panel (a) of FIG. 5 are shown in panel (b) of FIG. 5. The 3D-IFC images may also be used to detect cell doublets (e.g., cell images #7 and #13 in FIG. 5). The operation of identifying or resolving a doublet can facilitate the identification of a T-cell/cancer cell complex for T-cell receptor (TCR) and neoantigen detection, a step for CAR-T immunotherapy.

### Liver Disease Detection

Liver disease is a global healthcare burden, causing millions of deaths per year worldwide. The progression of liver disease may be divided into several stages. The hepatitis stellate cells (SC) from patients with early-stage liver disease would be a mixture of normal liver cells and cells in different stages of liver disease. Early-stage liver disease analysis and isolation are not only important in managing the disease but also beneficial in liver drug discovery and personalized medicine. The present technique offers the capability of imaging and isolating individual cells from a heterogenous particle population, which enables disease diagnosis and applications in drug discovery.

In an example implementation, the biopsy-proven non-alcoholic steatohepatitis (NASH) SC derived from a patient with early fibrosis stage 1/2 and SC from healthy control were studied. Both NASH SC and control SC were run separately in the 3D-IFC 170-10 at a rate of 300 cells/s to collect cell images. The NASH SC sample was mixed with marker beads (A, T, C) and the cells exiting the 3D-IFC 170-10 were dispensed on the membrane in the CPP 170-20 in a FIFO manner. Here 10-μm marker beads are represented by “A,” 20-μm marker beads by “T,” and 30-μm marker beads by “C.” A total of 11 morphological features from both 2D transmission images and 3D SSC images were extracted from these cell images by offline analysis. An unsupervised k-means clustering algorithm were applied using the features from NASH SC to separate normal liver cells from cells with liver disease. Then the features from control SC were used to examine the model clustering performance.

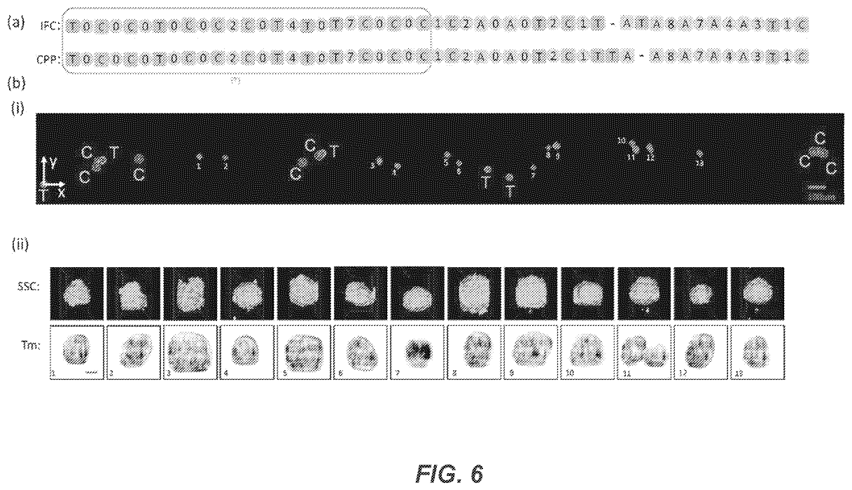

FIG. 6 shows diagrams illustrating example results from liver cells. Panel (a) of FIG. 6 shows a representative section of the matched IFC and CPP sequences. The IFC sequence may be determined based on imaging data acquired using the 3D-IFC 1270-10. The CPP sequence may be determined based on imaging data acquired using the CPP 1270-20. The number shown between a pair of neighboring marker beads in a sequence (e.g., the IFC sequence, the CPP sequence) indicates the number of cells (or cell count) of a portion of the sequence between the pair of neighboring marker beads. When the cell counts of the corresponding portions in the two sequences are the same, the system 170 determines that the two portions in the two sequences correspond to each other. Accordingly, the imaging date of the individual cells within the portion acquired by the 3D-IFC 170-10 can be correlated to the imaging data of the same cells acquired by the CPP 170-20; that is, for the individual cells in the portion, their imaging data from the 3D-IFC 170-10 and their imaging data from the CPP 170-20 may be correlated.

Panel (b) of FIG. 6 shows a representative section (in the box denoted by “*” in panel (a)) including marker beads and cell i. Panel (b)(i) of FIG. 6 shows low-resolution camera images for marker beads and cells on the membrane filter of CPP 170-20. The image resolution is sufficient for identification of the marker beads and the position information (in the form of, e.g., location coordinates) of the cells as indicated in Table 1. Panel (b) (ii) of FIG. 6 shows high resolution 3D SSC and fluorescent images and 2D transmission images of Liver cells from the 3D-IFC 170-10. The 3D-IFC images can be used to detect cell doublets (cell #11). The scale bar in panel b (i) of FIG. 6 represents 100 micrometers.

Panel (a) of FIG. 6 shows a representative section of the matched IFC and CPP sequences. The number shown between a pair of neighboring marker beads in a sequence (e.g., the IFC sequence, the CPP sequence) indicates the number of cells (or cell count) of a portion of the sequence between the pair of neighboring marker beads. When the cell counts of the corresponding portions in the two sequences are the same, the system 170 determines that the two portions in the two sequences correspond to each other. Accordingly, the imaging date of the individual cells within the portion acquired by the 3D-IFC 170-10 can be correlated to the imaging data of the same cells acquired by the CPP 170-20; that is, for the individual cells in the portion, their imaging data from the 3D-IFC 170-10 and their imaging data from the CPP 170-20 may be correlated. The cells on the membrane and their corresponding 3D images in the matched regions are shown in panel (b) of FIG. 6. Cell #11 is determined to be a doublet.

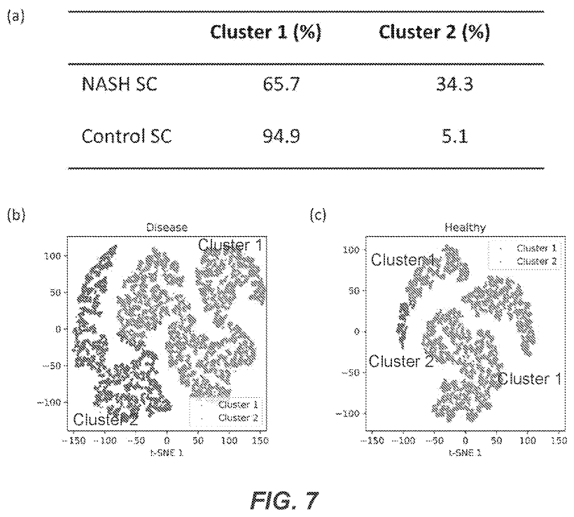

FIG. 7 shows the clustering results and the corresponding t-SNE visualizations for NASH SC and control SC. FIG. 7 shows liver cell clustering from healthy and early-stage NASH samples. Panel (a) of FIG. 7 shows cluster distributions of the NASH SC and the control SC. The clustering model was fitted using the dataset from the NASH HC. Then the model was used to predict the dataset from the control SC. Panel (b) of FIG. 7 shows t-SNE visualization of the clustering result of NASH SC dataset. In panel (b) of FIG. 7, the cluster 1 shows on right hand side in the panel, and the cluster 2 shows on the left hand side in the panel. Panel (c) of FIG. 7 shows t-SNE visualization of the clustering result of the Control SC dataset. Both datasets contain ˜15,000 3D cell images. In panel (c) of FIG. 7, the cluster 1 includes three portions, the portion on right hand side, the portion of the middle lower side, and the portion on the top right hand side in the panel; the cluster 2 includes a portion on the middle left hand side in the panel.

To pick up any selected cells based on their features recorded in imaging data acquired by the first imaging device (e.g., 3D-IFC 170-10), the cell positions in the particle holder may need to be determined. The cell positions may be random in the particle holder (e.g., on a porous membrane in the particle holder) due to one or more of several factors including, e.g., the Poisson statistics of the time when cells exit the 3D-IFC system, the finite size of the dispensing tip, and the relatively large amount of sheath flow that carries the cells. The ability of an automatic generation of cell position correlation allows for efficient and/or accurate selective cell pickup. To measure the location of the marker beads and cells on the membrane, the present technology provides image processing algorithms to identify the marker beads by size and record the position information (in the form of, e.g., location coordinates) of individual marker beads and cells. The present technology allows for distinguishing marker beads and cells from background features of the porous membrane. This disclosure shows how those background patterns of the porous membrane can be removed to produce images. See, e.g., in panel (b) of FIG. 4, panel (b) of FIG. 5, and panel (b) of FIG. 6.

FIG. 8 shows a diagram showing a process for a sequence extraction and image acquisition pipeline from an example implementation of a 3D imaging flow cytometry (3D-IFC). Also shown in FIG. 8 are examples for detected cell signal waveform after applying the cell detection algorithm in panel (a) and cell speed detection in panel (b). For cell speed detection, the example design includes the following parameters: a spacing between 2 slits of 200 micrometers in the image plane after 10× magnification by an objective lens; a sampling rate of 25 M Samples/second; a period indicating an average number of sampling point between two adjacent troughs (represented as * in the top curve in FIG. 8(b)). The sampling rate may relate to spatial resolution of the 3D-IFC. Panel (c) of FIG. 8 shows a 3D SSC image generated using signals from the SSC channel. Panel (d) of FIG. 8 shows a 3D fluorescence image generated using signals from the fluorescence (FL) channel.

FIG. 9 shows a diagram showing a process for sequence extraction and particle (including marker beads and cells) detection/pipeline from cell placement platform (CPP). The position information (in the form of, e.g., location coordinates) of the marker beads/cells in the particle holder (e.g., on a porous membrane in the particle holder) may be registered and the background interferences from the porous membrane are removed by the example algorithm shown in the pipeline. After particles are deposited on a membrane filter of the CPP at 910, an image is acquired using a 10× low-resolution microscope at 920. Panel (a) shows an example image acquired by performing the operation 920. Particles including marker beads and cells are registered at 930. Panels (b) and (c) show an example marker bead registration result and an example cell registration result, respectively, obtained by performing the operation 930. Sequence extraction is performed by removing background interference from the membrane filter at 940. Panel (d) shows an example sequence extraction result obtained by performing the operation 940.

As an example of using the low resolution, wide field-of-view imager in the CPP to register the position of the marker beads and cells, Table 1 lists the coordinates of the marker beads and cells on the membrane filter in panel (b) of FIG. 6. In the example, the imager has sufficient resolution to resolve the marker beads and the presence of cells between the marker beads and to register their positions with an accuracy of #10 μm, which is sufficient for the cell pickup tools. Table 1 also lists the extracted features and the clustering result. One can pick up chosen cells, for example, cells belong to cluster 2 on the membrane according to their location coordinates and transfer them to a common platform such as a 384-well plate for downstream analysis. The cell pick-up may be performed using, e.g., automated cell pickup heads by aspiration with a high rate and efficiency. Different treatments may be performed on certain cells based on their image analysis results and locations, which may be beneficial in the drug discovery area.

Table 1. Registration of marker beads and cells in the liver cell experiment (FIG. 5) by their position coordinate on the membrane filter and their corresponding feature extraction and clustering results.

TABLE 1

| | | Transmission Image [2D] | | | | SSC Image | | |
|---|---|---|---|---|---|---|---|---|
| | Position | Surface | Major | Minor | | | Surface | |
| Cell or | (x, y) | Area | Axis | Axis | Perimeter | Volume | Area | Clustering |
| Marker Bead | [symbol] | [symbol] | [symbol] | [symbol] | [symbol] | [symbol] | [symbol] | [symbol] |
| Marker Bead | (0, 0) | — | — | — | — | — | — | |
| Marker Bead | (299, [symbol] | — | — | — | — | — | — | |
| Marker Bead | (307, [symbol] | — | — | — | — | — | — | |
| Marker Bead | (334, [symbol] | — | — | — | — | — | — | |
| Marker Bead | (541, [symbol] | — | — | — | — | — | — | |
| Cell #1 | (887, [symbol] | 464.5 | 26.4 | 22.7 | 76.9 | 6495 | 1604 | 1 |
| Cell #2 | (1031, [symbol] | 648.5 | 33.2 | 24.9 | 92.3 | 1036 | 4532 | 1 |
| Marker Bead | (1480, [symbol] | — | — | — | — | — | — | |
| Marker Bead | (1576, [symbol] | — | — | — | — | — | — | |
| Marker Bead | (1593, [symbol] | — | — | — | — | — | — | |
| Cell #3 | (1920, [symbol] | 1125.3 | 39.2 | 36.8 | 122.1 | 2315 | 7705 | 2 |
| Cell #4 | (2026, [symbol] | 506.0 | 26.8 | 24.3 | 80.0 | 7160 | 2359 | 1 |
| Cell #5 | (2313, [symbol] | 909.7 | 34.4 | 34.2 | 109.3 | 1971 | 4842 | 1 |
| Cell #6 | (2379, [symbol] | 645.8 | 31.9 | 26.0 | 90.6 | 1042 | 3994 | 1 |
| Marker Bead | (2543, [symbol] | — | — | — | — | — | — | |
| Marker Bead | (2666, [symbol] | — | — | — | — | — | — | |
| Cell #7 | (2804, [symbol] | 394.0 | 23.8 | 21.7 | 74.8 | 5327 | 2471 | 1 |
| Cell #8 | (2890, [symbol] | 586.5 | 32.2 | 23.4 | 90.5 | 8442 | 3907 | 1 |
| Cell #9 | (2937, [symbol] | 814.5 | 35.0 | 29.8 | 103.7 | 1518 | 3705 | 1 |
| Cell #10 | (3368, [symbol] | 683.5 | 30.9 | 28.7 | 96.6 | 1239 | 3876 | 1 |
| Cell #11 | (3390, [symbol] | — | — | — | — | — | — | — |
| Cell #12 | (3475, [symbol] | 596.8 | 31.8 | 24.0 | 87.9 | 8791 | 3075 | 1 |
| Cell #13 | (3753, [symbol] | 506.0 | 28.0 | 23.2 | 81.1 | 7210 | 2396 | 1 |
| Marker Bead | (4402, [symbol] | — | — | — | — | — | — | |
| Marker Bead | (4431, [symbol] | — | — | — | — | — | — | |
| Marker Bead | (4459, [symbol] | — | — | — | — | — | — | |

[symbol]

indicates data missing or illegible when filed

The present technique relates 3D imaging features of individual particles (e.g., non-adherent cells) at high throughput to their spatial coordinates on a particle holder (e.g., a plate). Some example embodiments of the disclosed system include two parts: recording 3D particle images at high throughput (e.g., up to 1000 cells/s) using a 3D imaging flow cytometer (3D-IFC) and dispensing cells in a first-in-first-out (FIFO) manner using a robotic cell placement platform (CPP). When hundreds of thousands of cells pass the system in continuous operation for 10 minutes, errors due to violations of the FIFO principle may occur due to, e.g., occasional particle trapping inside the system or particle order scrambling due to disruption of the laminar flow. To prevent or alleviate the incorrect mapping of particle images to their positions on the particle holder (e.g., a cell placement membrane), the present technology uses marker beads and DNA sequencing software to detect errors and discard portions with high error probabilities. Using this technology, one can detect any errors and isolate the erroneous regions to prevent error propagation and accumulation. Proof-of-concept experiments with human cancer cell lines and healthy/diseased liver cells were performed to demonstrate the feasibility of the approach. Over 100,000 cells placed on the cell plates can be located based on their 3D side scattering and fluorescent images, as well as 2D transmission images. Since the position coordinate of every single cell on the cell placement membrane is recorded, our technique also allows users to pick up cells of specific phenotypes for cell-based assays, culturing, and downstream molecular analysis such as RNA sequencing, proteomic and metabolic analyses. In the example design used in the example implementation, cells may be placed on a porous membrane to keep cells wetted by the culture medium and conveniently aspirated without rupturing the cell membrane or excessive stress. Finally, while the present technology is described with respect to the 3D imaging flow cytometer as illustrated in FIG. 1D to produce the imaging data, the disclosed technology may be used with other imaging modalities such as a commercial 2D imaging flow cytometer.

### Example Implementation Materials and Methods

Human cancer cell lines preparation

The human embryonic kidney 293 cells (HEK-293), the Michigan Cancer Foundation-7 cells (MCF-7), and the cervical cancer cells (HeLa) were used in human cancer cell line classification. Cell lines were cultured with growth media (DMEM, 10% Fetal Bovine Serum, 1% Penicillin Streptomycin) in a 10 cm petri dish to 90% confluency before harvesting.

After culturing, cell lines were harvested and resuspended to a concentration of ˜1×10⁶ cells/mL in 1× PBS. The CFSE Cell Proliferation Kit (Ex/Em 492/517 nm, Cat. 34554, Thermo Fisher) was added to the cell suspension at a working concentration of 20 μM. For the CellTrace Yellow Proliferation Kit (Ex/Em 546/579 nm, Cat. 34567, Thermo Fisher), we prepared CellTrace stock solution immediately prior to use by adding the appropriate volume of DMSO (Component B) to one vial of CellTrace reagent (Component A) and then added the solution to the cell suspension at a working concentration of 5 μM. After incubating the cells at 37° C. for 30 minutes, fresh DMEM was used to quench the staining process, and the cells were washed with 1× PBS and fixed by 4% paraformaldehyde solution. The fixed cells were washed and resuspended in 1× PBS before imaging.

### Human Breast Epithelial Cells Preparation

The human breast epithelial cells (MCF-10A) were cultured with culture media (DMEM/F12 Ham's Mixture supplemented with 5% Equine Serum (Gemini Bio), EGF 20 ng/ml (Sigma), insulin 10 μg/ml (Sigma), hydrocortisone 0.5 mg/ml (Sigma), cholera toxin 100 ng/ml (Sigma), 100 units/ml penicillin and 100 μg/ml streptomycin) in a 15 cm petri dish to 90% confluency before harvesting. After culturing, cells were harvested and resuspended to a concentration of ˜1×10⁶ cells/mL in 1× PBS. The cells were then fixed by 4% paraformaldehyde solution. The fixed cells were washed and resuspended in 1× PBS before imaging.

### Stellate Cell Sample Preparation

Frozen vials of stellate cells were first thawed in a 37 degree C. water bath and then transferred to 5 mL media (DMEM, 10% Fetal Bovine Serum). Cells were then spun at 200 g for 5 minutes. The supernatant was removed, and the cells are resuspended in 1 mL of medium. They were then transferred to 2 mL of Williams E Medium.

### Experimental Sample Preparation

The cell sample was premixed with three non-fluorescent beads of different sizes: 10 um beads which we represented as nucleobase A, 20 um beads which we represented as nucleobase T, and 30 um beads which we represented as nucleobase C. To keep the average number of cells between marker beads to be a relatively small number (n=2) and minimize the chance of error, the ratio between cells and the total number of marker beads to be 2:1.

### Example Cell Culturing and Sample Preparation Protocols

### Human Cancer Cell Line Culturing

The human embryonic kidney 293 cells (HEK-293), the Michigan Cancer Foundation-7 cells (MCF-7) and the cervical cancer cells (HeLa) were used in human cancer cell line classification. Cell lines were all cultured with culture media (DMEM, 10% Fetal Bovine Serum, 1% Penicillin Streptomycin) in a 10 cm petri dish to 90% confluency before harvesting.

### The Human Breast Epithelial Cells (MCF-10A) Culturing

The human breast epithelial cells (MCF-10A) were cultured with culture media (DMEM/F12 Ham's Mixture supplemented with 5% Equine Serum (Gemini Bio), EGF 20 ng/ml (Sigma), insulin 10 μg/ml (Sigma), hydrocortisone 0.5 mg/ml (Sigma), cholera toxin 100 ng/ml (Sigma), 100 units/ml penicillin and 100 μg/ml streptomycin) in a 15 cm petri dish to 90% confluency before harvesting. After culturing, cells were harvested and resuspended to a concentration of ˜1×10⁶ cells/mL in 1× PBS. The cells are then fixed by 4% paraformaldehyde solution. The fixed cells were washed and resuspended in 1× PBS before imaging.

### Cell Line OFSE Staining And Celltrace Yellow Staining

After culturing, Cell lines were harvested and resuspended to a concentration of ˜1×10⁶ cells/mL in 1× PBS. The CFSE Cell Proliferation Kit (Ex/Em 492/517 nm, Cat. 34554, Thermo Fisher) was added to the cell suspension at a working concentration of 20μM. For the CellTrace Yellow Proliferation Kit (Ex/Em 546/579 nm, Cat. 34567, Thermo Fisher), we prepared CellTrace stock solution immediately prior to use by adding the appropriate volume of DMSO (Component B) to one vial of CellTrace reagent (Component A) and then added the solution to the cell suspension at a working concentration of 5 μM. After incubating the cells at 37° C. for 30 minutes, fresh culture medium (DMEM) was used to quench the staining process, and the cells were washed by 1× PBS and fixed by 4% paraformaldehyde solution. The fixed cells were washed and resuspended in 1× PBS before imaging.

### Tracking 3D) Cell Images and Their Position Experiment Sample Preparation

HeLa, MCF-7 and HEK-293 cells are used in this experiment. For the ground truth labelling HeLa and MCF-7 were fluorescently stained with the carboxyfluorescein succinimidyl ester (CFSE) Cell Proliferation Kit (Ex/Em 492/517 nm, Cat. 34554, Thermo Fisher) and the CellTrace Yellow Proliferation Kit (Ex/Em 546/579 nm, Cat. 34567, Thermo Fisher), respectively, while leaving the HEK-293 to be unstained. After the staining and fixation, cells are mixed to a 1-1-1 ratio before the experiment.

### Separating Breast Cancer Calls From Normal Cells Experiment Sample Preparation

MCF-7 and MCF-10A are used in this experiment. MCF-7 cells were fluorescently stained with the carboxyfluorescein succinimidyl ester (CFSE) Cell Proliferation Kit (Ex/Em 492/517 nm, Cat. 34554, Thermo Fisher), and the MCF-10A cells are not stained. After staining and fixation, MCF-7 and MCF-10A cells are mixed to a 1-1 ratio for the experiment.

### EXAMPLES

In some embodiments in accordance with the present technology (example A1), a system for processing a heterogeneous particle population is provided. The heterogeneous particle population may include object particles and marker particles. The system includes: a first imaging device to capture first imaging data of particles of the heterogenous particle population upon the particles travelling through the first imaging device, a particle dispenser in communication with the first imaging device and operable to dispense the particles exiting the first imaging device to a particle holder at respective holder positions; and a second imaging device to capture second imaging data of the particles positioned at their respective holder positions. The first imaging data includes first sequence information of a first sequence in which the particles are imaged in the first imaging device. The second imaging data includes second sequence information of a second sequence of the particles corresponding to their respective holder positions in the particle holder. The system includes a processor and a memory having instructions stored thereon, wherein the instructions upon execution by the processor cause the processor to locate an object particle of the heterogeneous particle population by correlating, based on sequence information of the marker particles in the first sequence information and in the second sequence information, information of the object particle in the first imaging data with information of the object particle in the second imaging data.

Example A2 includes the system of any of examples A1 or A3-A30, in which the first imaging device is an imaging flow cytometer.

Example A3 includes the system of any one of examples A1, A2, or A4-A30, in which the imaging flow cytometer is a two-dimensional or three-dimensional imaging flow cytometer.

Example A4 includes the system of any one of examples A1-A3 or A5-A30, in which the first imaging device includes a particle motion assembly to allow a suspension including the particles to move along a travel path while being imaged by the first imaging device.

Example A5 includes the system of any one of examples A1-A4 or A6-A30, in which the particle motion assembly includes a flow focusing unit configured to focus the particles into a single-particle stream to be imaged sequentially.

Example A6 includes the system of any one of examples A1-A5 or A7-A30, in which the single-particle stream has a particle concentration of at least 100 particles/μL.

Example A7 includes the system of any one of examples A1-A6 or A8-A30, in which the particle motion assembly includes a substrate on which the travel path is formed.

Example A8 includes the system of any one of examples A1-A7 or A9-A30, in which the first imaging device includes an optical illumination assembly to produce a light beam to illuminate one of the particles of the heterogenous particle population in a light interrogation area upon the particle travelling through the first imaging device along a travel path that traverses the light interrogation area and an optical detection assembly to detect optical signal data of the particle generated based on the light beam.

Example A9 includes the system of any one of examples A1-A8 or A10-A30, in which the light interrogation area includes an asymmetric illumination area of light, and the optical illumination assembly includes a light redirection device to modify the light beam by redirecting the light beam to provide the asymmetric illumination area of light.

Example A10 includes the system of any one of examples A1-A9 or A11-A30, in which the first imaging device includes a particle motion assembly to allow the particles to move along the travel path while being imaged by the first imaging device; and the optical detection device includes one or more photodetectors and a spatial filter positioned between the particle motion assembly and the one or more photodetectors.

Example A11 includes the system of any one of examples A1-A10 or A12-A30, in which the light interrogation area includes an asymmetric illumination area of light, and the spatial filter includes a plurality of apertures to selectively allow a portion of the asymmetric illumination area of light traversing the particle to pass through and be detected by the one or more photodetectors.

Example A12 includes the system of any one of examples A1-A11 or A13-A30, in which the particle dispenser is a robotic particle dispenser.

Example A13 includes the system of any one of examples A1-A12 or A14-A30, in which the second imaging device is an optical microscope.

Example A14 includes the system of any one of examples A1-A13 or A15-A30, in which the first sequence includes a first marker sequence according to which the marker particles are located in the first sequence; the second sequence includes a second marker sequence according to which the marker particles are located in the second sequence; and correlating the information of the object particle in the first imaging data with information of the object particle in the second imaging data includes mapping the first sequence with the second sequence based on the first marker sequence with the second marker sequence; and correlating the information of the object particle in the first imaging data with information of the object particle in the second imaging data based on the mapping.

Example A15 includes the system of any one of examples A1-A14 or A16-A30, in which the marker particles of the heterogenous particle population include first marker particles of a first marker type and second marker particles of a second marker type; the first marker sequence includes a first nucleotide symbol corresponding to each of the first marker particles and a second nucleotide symbol corresponding to each of the second marker particles; the second marker sequence includes the first nucleotide symbol corresponding to each of the first marker particles and the second nucleotide symbol corresponding to each of the second marker particles; and mapping the first sequence with the second sequence based on the first marker sequence and the second marker sequence is performed based on a DNA sequencing algorithm.

Example A16 includes the system of any one of examples A1-A15 or A17-A30, in which mapping the first sequence with the second sequence based on the first marker sequence and the second marker sequence includes identifying, in the first marker sequence, a first target marker pair including a marker particle A and a marker particle B that is positioned downstream of and next to the marker particle A in the first marker sequence; identifying, in the second marker sequence, a second target marker pair including a marker particle C and a marker particle D, the marker particle C being of a same type as the marker particle A, the marker particle D being of a same type as the marker particle B and downstream of and next to the marker particle C in the second marker sequence; determining, based on the first imaging data, a first particle count of particles located between the marker particle A and the marker particle B in the first sequence; determining, based on the second imaging data, a second particle count of particles located between the marker particle C and the marker particle D in the second sequence; and in response to determining that the first particle count equals the second particle count, determining that a first target portion of the first sequence between the marker A and the marker B corresponds to a second target portion of the second sequence between the marker C and the marker D.

Example A17 includes the system of any one of examples A1-A16 or A18-A30, in which mapping the first sequence with the second sequence based on the first marker sequence and the second marker sequence further includes identifying an error portion of the first sequence or an error portion of the second sequence.

Example A18 includes the system of any one of examples A1-A17 or A19-A30, in which identifying the error portion of the first sequence or the error portion of the second sequence based on the first marker sequence and the second marker sequence includes identifying, in the first marker sequence, a first target marker pair including a marker particle A and a marker particle B that is positioned downstream of and next to the marker particle A in the first marker sequence; identifying, in the second marker sequence, a second target marker pair including a marker particle C and a marker particle D, the marker particle C being of a same type as the marker particle A, the marker particle D being of a same type as the marker particle B and downstream of and next to the marker particle C in the second marker sequence; determining, based on the first imaging data, a first particle count of particles located between the marker particle A and the marker particle B in the first sequence; determining, based on the second imaging data, a second particle count of particles located between the marker particle C and the marker particle D in the second sequence; and in response to determining that the first particle count is different from the second particle count, performing at least one of: determining that a first portion of the first sequence between the marker A and the marker B constitutes the error portion of the first sequence; determining that a second portion of the second sequence between the marker C and the marker D constitutes the error portion of the second sequence; determining that the first portion does not correspond to the second portion; or removing the first portion or the second portion from further analysis.

Example A19 includes the system of any one of examples A1-A18 or A20-A30, in which identifying the error portion of the first sequence or the error portion of the second sequence based on the first marker sequence and the second marker sequence includes identifying, an error marker portion of the first marker sequence or of the second marker sequence. In some embodiments, the error marker portion corresponds to at least one of a deletion error or a misplacement error, the error portion includes a marker particle E and a marker particle F. In some embodiments, the error portion of the first sequence includes particles located between the marker particle E and the marker particle F in the first sequence. In some embodiments, the error portion of the second sequence includes particles located between the marker particle E and the marker particle F in the second sequence.

Example A20 includes the system of any one of examples A1-A19 or A21-A30, in which the object particles of the heterogeneous particle population include first object particles and second object particles. The first object particles include cells from one or more samples with a pathological condition. The second object particles include cells from one or more samples with a control condition.

Example A21 includes the system of any one of examples A1-A20 or A22-A30, in which the particle dispenser dispenses the particles exiting the first imaging device to the particle holder in a substantially first-in-first-out manner.

Example A22 includes the system of any one of examples A1-A21 or A23-A30, in which the respective holder positions constitute multiple rows; and each two neighboring rows of the multiple rows are spaced apart by an inter-row spacing that equals or exceeds a spatial resolution of the second imaging device.

Example A23 includes the system of any one of examples A1-A22 or A24-A30, in which two neighboring holder positions of the respective holder positions that are in a same row of the multiple rows are spaced by an intra-row spacing that equals or exceeds the spatial resolution of the second imaging device.

Example A24 includes the system of any one of examples A1-A23 or A25-A30, in which the inter-row spacing is the same as or different from the intra-row spacing.

Example A25 includes the system of any one of examples A1-A24 or A26-A30, in which the particle holder is configured to drain liquid that travels with the particles in the first imaging device after the liquid exits the first imaging device.

Example A26 includes the system of any one of examples A1-A25 or A27-A30, in which the particle holder comprises a sheet on which the particles are positioned.

Example A27 includes the system of any one of examples A1-A26 or A28-A30, in which the particle holder comprises a plurality of wells, and each of the particles is placed in one of the plurality of wells.

Example A28 includes the system of any one of examples A1-A27, A29, or A30, in which the first imaging device is operable to record multi-parameter 3D particle images of the particles travelling in the first imaging device at a throughput rate of at least 100 cells/second.

Example A29 includes the system of any one of examples A1-A28 or A30, in which the throughput rate is 200 cells/second, 300 cells/second, 500 cells/second, 600 cells/second, 800cells/second, or 1000 cells/second.

Example A30 includes the system of any one of examples A1-A29, in which the system is operable to process the first imaging data produce at least one of a 3D tomographic image, a 3D side scattering and fluorescent images, or a 2D transmission image.

In some embodiments in accordance with the present technology (example B1), a method for processing a heterogeneous particle population includes obtaining first imaging data of particles of the heterogenous particle population captured by a first imaging device upon the particles travelling through the first imaging device, and obtaining second imaging data of the particles captured using a second imaging device when the particles are positioned at their respective holder positions in a particle holder. The heterogeneous particle population include object particles and marker particles. The first imaging data includes first sequence information of a first sequence in which the particles are imaged in the first imaging device. The second imaging data includes second sequence information of a second sequence of the particles corresponding to their respective holder positions in the particle holder. The method further includes locating an object particle of the heterogeneous particle population by correlating, based on sequence information of the marker particles in the first sequence information and in the second sequence information, information of an object particle in the first imaging data with information of the object particle in the second imaging data.

Example B2 includes the method of any one of examples B1 or B3-B20, further including forming a two-dimensional (2D) hydrodynamically focused single-particle stream of the particles; and capturing the first imaging data by illuminating the single-particle stream.

Example B3 includes the method of any one of examples B1, B2, or B4-B20, further including dispensing, using a particle dispenser in communication with the first imaging device, the particles exiting the first imaging device to at their respective holder positions in the particle holder.

Example B4 includes the method of any one of examples B1-B3 or B5-B20, in which dispensing the particles exiting the first imaging device proceeds in a substantially first-in-first-out manner.

Example B5 includes the method of any one of examples B1-B4 or B6-B20, in which the first sequence includes a first marker sequence according to which the marker particles are located in the first sequence; the second sequence includes a second marker sequence according to which the marker particles are located in the second sequence; and correlating the information of the object particle in the first imaging data with information of the object particle in the second imaging data includes mapping the first sequence with the second sequence based on the first marker sequence with the second marker sequence; and correlating the information of the object particle in the first imaging data with information of the object particle in the second imaging data based on the mapping.

Example B6 includes the method of any one of examples B1-B5 or B7-B20, in which mapping the first sequence with the second sequence based on the first marker sequence and the second marker sequence includes identifying, in the first marker sequence, a first target marker pair including a marker particle A and a marker particle B that is positioned downstream of and next to the marker particle A in the first marker sequence; identifying, in the second marker sequence, a second target marker pair including a marker particle C and a marker particle D, the marker particle C being of a same type as the marker particle A, the marker particle D being of a same type as the marker particle B and downstream of and next to the marker particle C in the second marker sequence; determining, based on the first imaging data, a first particle count of particles located between the marker particle A and the marker particle B in the first sequence; determining, based on the second imaging data, a second particle count of particles located between the marker particle C and the marker particle D in the second sequence; and in response to determining that the first particle count equals the second particle count, determining that a first target portion of the first sequence between the marker A and the marker B corresponds to a second target portion of the second sequence between the marker C and the marker D.

Example B7 includes the method of any one of examples B1-B6 or B8-B20, in which mapping the first sequence with the second sequence based on the first marker sequence and the second marker sequence further includes identifying an error portion of the first sequence or an error portion of the second sequence.

Example B8 includes the method of any one of examples B1-B7 or B9-B20, in which identifying the error portion of the first sequence or the error portion of the second sequence based on the first marker sequence and the second marker sequence includes identifying, in the first marker sequence, a first target marker pair including a marker particle A and a marker particle B that is positioned downstream of and next to the marker particle A in the first marker sequence; identifying, in the second marker sequence, a second target marker pair including a marker particle C and a marker particle D, the marker particle C being of a same type as the marker particle A, the marker particle D being of a same type as the marker particle B and downstream of and next to the marker particle C in the second marker sequence; determining, based on the first imaging data, a first particle count of particles located between the marker particle A and the marker particle B in the first sequence; determining, based on the second imaging data, a second particle count of particles located between the marker particle C and the marker particle D in the second sequence; and in response to determining that the first particle count is different from the second particle count, performing at least one of: determining that a first portion of the first sequence between the marker A and the marker B constitutes the error portion of the first sequence; determining that a second portion of the second sequence between the marker C and the marker D constitutes the error portion of the second sequence; determining that the first portion does not correspond to the second portion; or removing the first portion or the second portion from further analysis.

Example B9 includes the method of any one of examples B1-B8 or B10-B20, in which identifying the error portion of the first sequence or the error portion of the second sequence based on the first marker sequence and the second marker sequence includes identifying, an error marker portion of the first marker sequence or of the second marker sequence. In some embodiments, the error marker portion corresponds to at least one of a deletion error or a misplacement error, and the error portion includes a marker particle E and a marker particle F. In some embodiments, the error portion of the first sequence includes particles located between the marker particle E and the marker particle Fin the first sequence; and the error portion of the second sequence includes particles located between the marker particle E and the marker particle F in the second sequence.

Example B10 includes the method of any one of examples B1-B9 or B10-B20, in which the marker particles of the heterogenous particle population include first marker particles of a first marker type and second marker particles of a second marker type; the first marker sequence includes a first nucleotide symbol corresponding to each of the first marker particles and a second nucleotide symbol corresponding to each of the second marker particles; the second marker sequence includes the first nucleotide symbol corresponding to each of the first marker particles and the second nucleotide symbol corresponding to each of the second marker particles; and mapping the first sequence with the second sequence based on the first marker sequence and the second marker sequence is performed based on a DNA sequencing algorithm.

Example B11 includes the method of any one of examples B1-B10 or B12-B20, in which the object particles of the heterogeneous particle population include first object particles and second object particles. The first object particles include cells from one or more samples with a pathological condition. The second object particles include cells from one or more samples with a control condition.

Example B12 includes the method of any one of examples B1-B11 or B13-B20, in which locating the object particle includes determining a holder position of the object.

Example B13 includes the method of any one of examples B1-B12 or B14-B20, further including generating a particle map that includes the respective holder positions and particle types of the particles at respective holder positions.

Example B14 includes the method of any one of examples B1-B13 or B15-B20, in which generating a particle map includes for each of the object particles of the heterogenous particle population, determining a holder position of the object particle by correlating, based on the sequence information of the marker particles in the first sequence information and in the second sequence information, information of the object particle in the first imaging data and information of the object particle in the second imaging data.

Example B15 includes the method of any one of examples B1-B14 or B16-B20, further including identifying the object particles in the particle holder based on the particle map; and processing at least one of the identified object particles by at least one of: culturing, performing a genetic sequencing, removal from the particle holder, staining, or imaging.

Example B16 includes the method of any one of examples B1-B15 or B17-B20, in which the particle holder includes a sheet on which the particles are positioned; and the culturing includes removing particles other than the object particles from the sheet based on the particle map; and placing the sheet, or a portion thereof, including the at least one of the object particles in a cell culture medium.

Example B17 includes the method of any one of examples B1-B16 or B18-B20, in which culturing includes picking up the at least one of the identified object particles from the particle holder; pooling the at least one of the identified object particles; and culturing the pooled object particles.

Example B18 includes the method of any one of examples B1-B17, B19, or B20, in which the particle holder includes a plurality of wells; each of the identified object particles is positioned in one of the plurality of wells; and the culturing includes culturing the at least one of the object particles in its respective well.

Example B19 includes the method of any one of examples B1-B18 or B20, further including collecting secretion of the cultured object particles; and analyzing the collected secretion.

Example B20 includes the method of any one of examples B1-B19, further including forming a microcolony by the culturing of the at least one of the identified object particles.

In some embodiments in accordance with the present technology (example C1), a system for processing a heterogeneous particle population includes a camera-less first imaging device with a scanning light-sheet and one or more spatial masks, wherein the first imaging device is operable to capture first imagine data including or corresponding to (i) 3D side scattering and fluorescent images, (ii) a 2D transmission image, or (iii) both (i) and (ii) of traveling particles, a particle dispenser for dispending the particles exiting the first imaging device to a particle holder at respective holder positions, and a second imaging device to obtain second imaging data by imaging the particles at their respective holder positions, wherein the system is operable to correlate the first imaging data and the second imaging data.

In some embodiments in accordance with the present technology (example D1), a non-transitory computer readable program storage medium having code stored thereon, the code, when executed by a processor, causing the processor to implement a method of any one of examples B1-B20.

In some embodiments in accordance with the present technology (example E1), a system, including at least one processor and memory including computer program code which, when executed by the at least one processor, causes the system to effectuate a method of any one of examples B1-B20.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

The term “about,” as used herein when referring to a measurable value such as an amount or concentration and the like, is meant to encompass variations of 20%, 10%, 5%, 1%, 0.5%, or even 0.1% of the specified amount.

It is intended that the specification, together with the drawings, be considered exemplary only, where exemplary means an example. As used herein, the singular forms “a”, “an” and “the” are intended to include the plural forms as well, unless the context clearly indicates otherwise. Additionally, the use of “or” is intended to include “and/or”, unless the context clearly indicates otherwise.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

1. A system for processing a heterogeneous particle population that includes object particles and marker particles, comprising:
a first imaging device operable to capture first imaging data of particles of the heterogenous particle population upon the particles travelling through the first imaging device, wherein:
the first imaging data comprises first sequence information of a first sequence in which the particles are imaged in the first imaging device;
a particle dispenser in communication with the first imaging device and operable to dispense the particles exiting the first imaging device to a particle holder at respective holder positions; and
a second imaging device operable to capture second imaging data of the particles positioned at their respective holder positions, wherein:
the second imaging data comprises second sequence information of a second sequence of the particles corresponding to their respective holder positions in the particle holder; and
a processor and a memory having instructions stored thereon, wherein the instructions upon execution by the processor cause the processor to:
locate an object particle of the heterogeneous particle population by correlating, based on sequence information of the marker particles in the first sequence information and in the second sequence information, information of the object particle in the first imaging data with information of the object particle in the second imaging data.

2. The system of claim 1, wherein the first imaging device is an imaging flow cytometer.

3. The system of claim 2, wherein the imaging flow cytometer is a two-dimensional or three-dimensional imaging flow cytometer.

4. The system of claim 1, wherein the first imaging device comprises a particle motion assembly to allow a suspension including the particles to move along a travel path while being imaged by the first imaging device.

5. The system of claim 4, wherein the particle motion assembly comprises a flow focusing unit configured to focus the particles into a single-particle stream to be imaged sequentially.

6. (canceled)

7. The system of claim 4, wherein the particle motion assembly comprises a substrate on which the travel path is formed.

8. The system of claim 1, wherein the first imaging device comprises:
an optical illumination assembly operable to produce a light beam to illuminate one of the particles in a light interrogation area upon the particle travelling through the first imaging device along a travel path that traverses the light interrogation area, and
an optical detection assembly operable to detect optical signal data of the particle generated based on the light beam.

9. The system of claim 8, wherein:
the light interrogation area is an asymmetric illumination area of light, and
the optical illumination assembly comprises a light redirection device to modify the light beam by redirecting the light beam to provide the asymmetric illumination area of light.

10. The system of claim 8, wherein:
the first imaging device comprises a particle motion assembly to allow the particles to move along the travel path while being imaged by the first imaging device; and
the optical detection device comprises one or more photodetectors and a spatial filter positioned between the particle motion assembly and the one or more photodetectors.

11. The system of claim 10, wherein:
the light interrogation area is an asymmetric illumination area of light, and
the spatial filter comprises a plurality of apertures to selectively allow a portion of the asymmetric illumination area of light traversing the particle to pass through and be detected by the one or more photodetectors.

12. The system of claim 1, wherein the particle dispenser is a robotic particle dispenser.

13. The system of claim 1, wherein the second imaging device is an optical microscope.

14. The system of claim 1, wherein:
the first sequence comprises a first marker sequence according to which the marker particles are located in the first sequence;
the second sequence comprises a second marker sequence according to which the marker particles are located in the second sequence; and
correlating the information of the object particle in the first imaging data with information of the object particle in the second imaging data comprises:
mapping the first sequence with the second sequence based on the first marker sequence with the second marker sequence; and
correlating the information of the object particle in the first imaging data with information of the object particle in the second imaging data based on the mapping.

15. The system of claim 14, wherein:
the marker particles of the heterogenous particle population comprise first marker particles of a first marker type and second marker particles of a second marker type;
the first marker sequence comprises a first nucleotide symbol corresponding to each of the first marker particles and a second nucleotide symbol corresponding to each of the second marker particles;
the second marker sequence comprises the first nucleotide symbol corresponding to each of the first marker particles and the second nucleotide symbol corresponding to each of the second marker particles; and
mapping the first sequence with the second sequence based on the first marker sequence and the second marker sequence is performed based on a DNA sequencing algorithm.

16. The system of claim 14, wherein mapping the first sequence with the second sequence based on the first marker sequence and the second marker sequence comprises:
identifying, in the first marker sequence, a first target marker pair including a marker particle A and a marker particle B that is positioned downstream of and next to the marker particle A in the first marker sequence;
identifying, in the second marker sequence, a second target marker pair including a marker particle C and a marker particle D, the marker particle C being of a same type as the marker particle A, the marker particle D being of a same type as the marker particle B and downstream of and next to the marker particle C in the second marker sequence;
determining, based on the first imaging data, a first particle count of particles located between the marker particle A and the marker particle B in the first sequence;
determining, based on the second imaging data, a second particle count of particles located between the marker particle C and the marker particle D in the second sequence; and
in response to determining that the first particle count equals the second particle count, determining that a first target portion of the first sequence between the marker A and the marker B corresponds to a second target portion of the second sequence between the marker C and the marker D.

17. The system of claim 14, wherein mapping the first sequence with the second sequence based on the first marker sequence and the second marker sequence comprises:
identifying an error portion of the first sequence or an error portion of the second sequence.

18-29. (canceled)

30. The system of claim 1, wherein the system is operable to process the first imaging data produce at least one of a 3D tomographic image, a 3D side scattering and fluorescent images, or a 2D transmission image.

31. A method for processing a heterogeneous particle population that includes object particles and marker particles, comprising:
obtaining first imaging data of particles of the heterogenous particle population captured by a first imaging device upon the particles travelling through the first imaging device, wherein the first imaging data comprises first sequence information of a first sequence in which the particles are imaged in the first imaging device;
obtaining second imaging data of the particles captured using a second imaging device when the particles are positioned at their respective holder positions in a particle holder, wherein the second imaging data comprises second sequence information of a second sequence of the particles corresponding to their respective holder positions in the particle holder; and
locating an object particle of the heterogeneous particle population by correlating, based on based on sequence information of the marker particles in the first sequence information and in the second sequence information, information of the object particle in the first imaging data with information of the object particle in the second imaging data.

32. The method of claim 31, further comprising:
forming a two-dimensional (2D) hydrodynamically focused single-particle stream of the particles; and
capturing the first imaging data by illuminating the single-particle stream.

33-50. (canceled)

51. A system for processing a heterogeneous particle population, comprising:
a camera-less first imaging device with a scanning light-sheet and one or more spatial masks, wherein the first imaging device is operable to capture first imagine data including or corresponding to (i) 3D side scattering and fluorescent images, (ii) a 2D transmission image, or (iii) both (i) and (ii) of traveling particles,
a particle dispenser for dispending the particles exiting the first imaging device to a particle holder at respective holder positions, and
a second imaging device to obtain second imaging data by imaging the particles at their respective holder positions, wherein the system is operable to correlate the first imaging data and the second imaging data.

52. (canceled)

53. (canceled)
